(19) United States
(12) Patent Application Publication
(10) Pub. No.: US 2002/0069142 A1
(43) Pub. Date: Jun. 6, 2002

(54) Method and system for tracking and disseminating information concerning tools

(76) Inventors: Tim Opstrup, Madison, CT (US); Tom Mathis, Farmington, CT (US)

Correspondence Address: John S. Beulick, Armstrong Teasdale LLP, Suite 2600, One Metropolitan Sq., St. Louis, MO, 63102, US

(21) Appl. No.: 09/730,169

(22) Filed: Dec. 5, 2000

(51) Int. Cl. G06F 17/60

(52) U.S. Cl. 705/30

(57) ABSTRACT

A web-based method and system for tracking tool costs and processing funding requests for tools includes receiving information concerning a tool from a user and allowing another user to view the tool information and funding request, and either approve or disapprove the request.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

This invention relates generally to computer network-based wizards and more particularly to a network-based method and system for tracking and disseminating information and funding requests concerning tools.

Corporations typically control manufacturing costs carefully to be successful, which in turn entails tracking those costs and disseminating cost and maintenance information to those in need of it. Corporations, especially with remote facilities, and possibly a variety of external vendors, face difficulties in tracking and disseminating the costs associated with providing and using tools used to produce their products. If the corporation purchases the tools for its vendors, the corporation receives funding requests from them, decides which ones to approve, and informs applicants of the fate of their funding applications. It would therefore be desirable to have a method for tracking costs associated with the provision and maintenance of the tools that produce products that could be used over a large geographical area and across a plurality of organizations.

### BRIEF SUMMARY OF THE INVENTION

In an exemplary embodiment, a web-based method and system for tracking tool costs and processing funding requests for tools includes receiving at least one of information and a funding request concerning a tool from a user and allowing another user to view the tool information and funding requests, and either approve or disapprove the funding requests.

The tool information includes, for example, features of the tool, cost of the tool, and maintenance status of the tool. The method and system further include quotes offered for production of the tool, purchase orders concerning the tool, funding requests concerning the tool, quotes for production of the tool, and approval status of the funding request for production of the tool.

### BRIEF DESCRIPTION OF THE DRAWINGS

FIG. 1 is a block diagram of a system in accordance with one embodiment of the present invention;

FIG. 2 is an expanded block diagram of a web-based method for soliciting, receiving, compiling, and disseminating information concerning attributes of a product;

FIG. 3 is a process flow diagram of a web-based method for tracking tool information and accepting funding requests for tools;

FIG. 4 is an exemplary embodiment of a GE Main Screen;

FIG. 5 is an exemplary embodiment of a Main Screen/Parts Database/Modify Parts page;

FIG. 6 is an exemplary embodiment of a GE Main Screen/Parts Database/Modify Parts—submit page;

FIG. 7 is a continuation page of a Main Screen/Parts Database/Modify Parts—submit page;

FIG. 8 is an exemplary embodiment of Main Screen/Parts Database/Modify Parts—upload or download page;

FIG. 9 is an exemplary embodiment of a GE Main Screen/Parts Database/View Part Details page;

FIG. 10 is an exemplary embodiment of a GE Main Screen/Parts Database/View Part Details—submit page;

FIG. 11 is a continuation page of a GE Main Screen/Parts Database/View Part Details—submit page;

FIG. 12 is an exemplary embodiment of a GE Main Screen/Funding/New Funding Request page;

FIG. 13 is an exemplary embodiment of a GE Main Screen/Funding/New Funding Request—submit page;

FIG. 14 is an exemplary embodiment of a GE Main Screen/Funding/New Funding Request—submit/part # link page;

FIG. 15 is an exemplary embodiment of a GE Main Screen/Funding/New Funding Request—submit/approving plant link page;

FIG. 16 is an exemplary embodiment of a GE Main Screen/Parts Database/Modify Parts—submit/priority link page;

FIG. 17 is an exemplary embodiment of a GE Main Screen/Funding/New Funding Request—submit/other quotes link page;

FIG. 18 is an exemplary embodiment of a GE Main Screen/Funding/Pending Funding Requests page;

FIG. 19 is an exemplary embodiment of a GE Main Screen/Funding/Pending Funding Requests—submit page;

FIG. 20 is an exemplary embodiment of a GE Main Screen/Funding/Approved Awaiting PO page;

FIG. 21 is an exemplary embodiment of a GE Main Screen/Funding/Approved Awaiting PO—submit page;

FIG. 22 is an exemplary embodiment of a GE Main Screen/Funding/Approved Awaiting PO—submit/Quote link page;

FIG. 23 is an exemplary embodiment of a GE Main Screen/Funding/Approved Awaiting Completion page;

FIG. 24 is an exemplary embodiment of a GE Main Screen/Funding/Approved Awaiting Completion—submit page;

FIG. 25 is an exemplary embodiment of a GE Main Screen/Funding/S-II Submittals page;

FIG. 26 is an exemplary embodiment of a GE Main Screen/Funding/S-II Submittals—submit page;

FIG. 27 is an exemplary embodiment of a GE Main Screen/Funding/S-II Submittals—submit/run scenario page;

FIG. 28 is an exemplary embodiment of a GE Main Screen/Funding/S-II Submittals—submit/run scenario/submit page;

FIG. 29 is an exemplary embodiment of a GE Main Screen/Funding/Summary page;

FIG. 30 is an exemplary embodiment of a GE Main Screen/Funding/Summary—submit page;

FIG. 31 is an exemplary embodiment of a GE Main Screen/Funding/Other Tool Approvals page;

FIG. 32 is an exemplary embodiment of a GE Main Screen/Funding/Other Tool Approvals—submit page;

FIG. 33 is an exemplary embodiment of a Supplier Main Screen;

FIG. 34 is an exemplary embodiment of a Supplier Main Screen/Parts Database/Add New Part page;

FIG. 35 is an exemplary embodiment of a Supplier Main Screen/Parts Database/ Database/Add New Part—submit page;

FIG. 36 is a continuation page of a Main Screen/Parts Database/ Database/Add New Part—submit page;

FIG. 37 is an exemplary embodiment of a Supplier Main Screen/Parts Database/Add New Part—upload or download page;

FIG. 38 is an exemplary embodiment of a Supplier Main Screen/Parts Database/Modify Parts page;

FIG. 39 is an exemplary embodiment of a Supplier Main Screen/Parts Database/ Modify Parts—submit page;

FIG. 40 is a continuation page of a Supplier Main Screen/Parts Database/Modify Parts—submit page;

FIG. 41 is an exemplary embodiment of a Supplier Main Screen/Parts Database/Modify Parts—upload or download page;

FIG. 42 is an exemplary embodiment of a Supplier Main Screen/Parts Database/View Part Details page;

FIG. 43 is an exemplary embodiment of a Supplier Main Screen/Funding/New Funding Request—submit/part # link page;

FIG. 43 is an exemplary embodiment of a Supplier Main Screen/Parts Database/View Part Details—submit page;

FIG. 44 is a continuation page of a Supplier Main Screen/Parts Database/View Part Details—submit page;

FIG. 45 is an exemplary embodiment of a Supplier Main Screen/Parts Database/Contact Supplier page;

FIG. 46 is an exemplary embodiment of a Supplier Main Screen/Parts Database/Contact Supplier—submit page;

FIG. 47 is an exemplary embodiment of a Supplier Main Screen/Funding/Funding Request page;

FIG. 48 is an exemplary embodiment of a Supplier Main Screen/Funding/Funding Request—submit page;

FIG. 49 is an exemplary embodiment of a Supplier Main Screen/Funding/Funding Request—submit/part # link page;

FIG. 50 is an exemplary embodiment of a Supplier Main Screen/Funding/Funding Request—submit/approving plant link page;

FIG. 51 is an exemplary embodiment of a Supplier Main Screen/Funding/Funding Request—submit/set priority link page;

FIG. 52 is an exemplary embodiment of a Supplier Main Screen/Funding/Funding Request—submit/other quotes link page;

FIG. 53 is an exemplary embodiment of a Supplier Main Screen/Funding/Productivity Projects page;

FIG. 54 is an exemplary embodiment of a Supplier Main Screen/Funding/Productivity Projects—submit page;

FIG. 55 is an exemplary embodiment of a Supplier Main Screen/Funding/Modify Existing Quotes page;

FIG. 56 is an exemplary embodiment of a Supplier Main Screen/Funding/Modify Existing Quotes—submit page;

FIG. 57 is an exemplary embodiment of a Supplier Main Screen/Funding/Active Summary page;

FIG. 58 is an exemplary embodiment of a Supplier Main Screen/Funding/Active Summary—submit page;

FIG. 59 is an exemplary embodiment of a Supplier Main Screen/Funding/Active Summary—submit/quote # link page;

FIG. 60 is an exemplary embodiment of a Supplier Main Screen/Funding/Active Summary—submit/approval status link page;

FIG. 61 is an exemplary embodiment of a Supplier Main Screen/Funding/Historical Summary page;

FIG. 62 is an exemplary embodiment of a Supplier Main Screen/Funding/Historical Summary—submit page; and

FIG. 63 is an exemplary embodiment of a Supplier Main Screen/Funding/Historical Summary—submit/PO & Invoice link page.

### DETAILED DESCRIPTION OF THE INVENTION

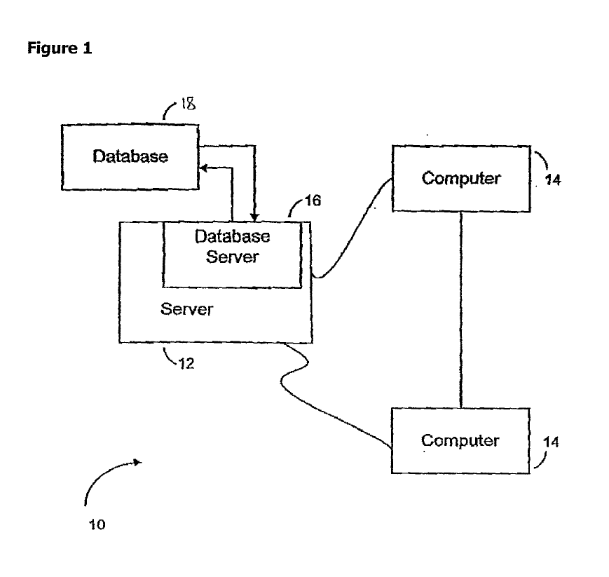

FIG. 1 is a block diagram of a system 10 in accordance with one embodiment of the present invention. System 10 includes a server sub-system 12 and a plurality of user devices 14 connected to server sub-system 12, sometimes referred to herein as server 12. In one embodiment, devices 14 are computers including a web browser, and server 12 is accessible to devices 14 via a network such as an intranet or the Internet. In an alternative embodiment, devices 14 are servers for a network of customer devices.

Devices 14 are interconnected to the network, such as a local area network (LAN) or a wide area network (WAN), through many interfaces including dial-in-connections, cable modems and high-speed ISDN lines. Alternatively, devices 14 are any device capable of interconnecting to a network including a web-based phone or other web-based connectable equipment. Server sub-system 12 includes a database server 16 connected to a centralized database 18 containing tool-related information on a variety of technologies, as described below in greater detail. In one embodiment, centralized database 18 is stored on database server 16 and can be accessed by potential users at one of user devices 14 by logging onto server sub-system 12 through one of user devices 14. In an alternative embodiment centralized database 18 is stored remotely from server sub-system 12.

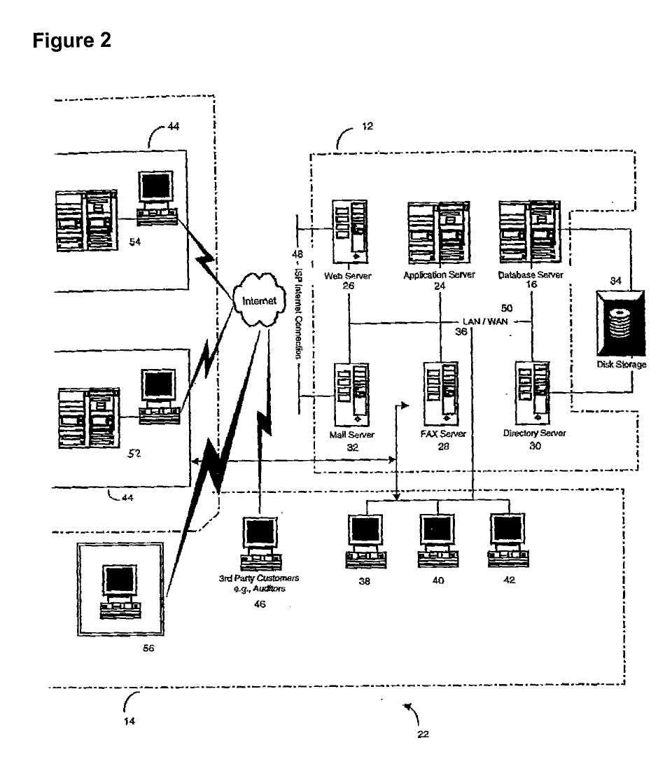

FIG. 2 is an expanded version block diagram of an exemplary embodiment of a server architecture of a system 22 for soliciting, receiving, compiling, and disseminating information concerning attributes of a product. System 22 includes server sub-system 12 and user devices 14. Server sub-system 12 includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator workstation 38, a user workstation 40, and a supervisor workstation 42 are coupled to LAN 36. Alternatively, workstations 38, 40, and 42 are coupled to LAN 36 via an Internet link or are connected through an intranet.

Each workstation 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

In another embodiment, server sub-system 12 is configured to be communicatively coupled to various individuals or employees 44 and to users 46 via an ISP Internet connection 48. The communication in the exemplary embodiment is illustrated as being performed via the Internet, however, any other wide area network (WAN) type communication can be used in other embodiments, i.e., the systems and processes are not limited to being practiced via the Internet. In addition, and rather than a WAN 50, local area network 36 could be used in place of WAN 50.

In the exemplary embodiment, any authorized individual or an employee of the business entity having a workstation 52 can access server sub-system 12. One of user devices 14 includes a senior manager's workstation 54 located at a remote location. Work stations 52 and 54 are personal computers having a web browser. Also, work stations 52 and 54 are configured to communicate with server sub-system 12. Furthermore, fax server 28 communicates with employees located outside the business entity and any of the remotely located user systems, including a user system 56 via a telephone link. Fax server 28 is configured to communicate with other workstations 38, 40, and 42 as well.

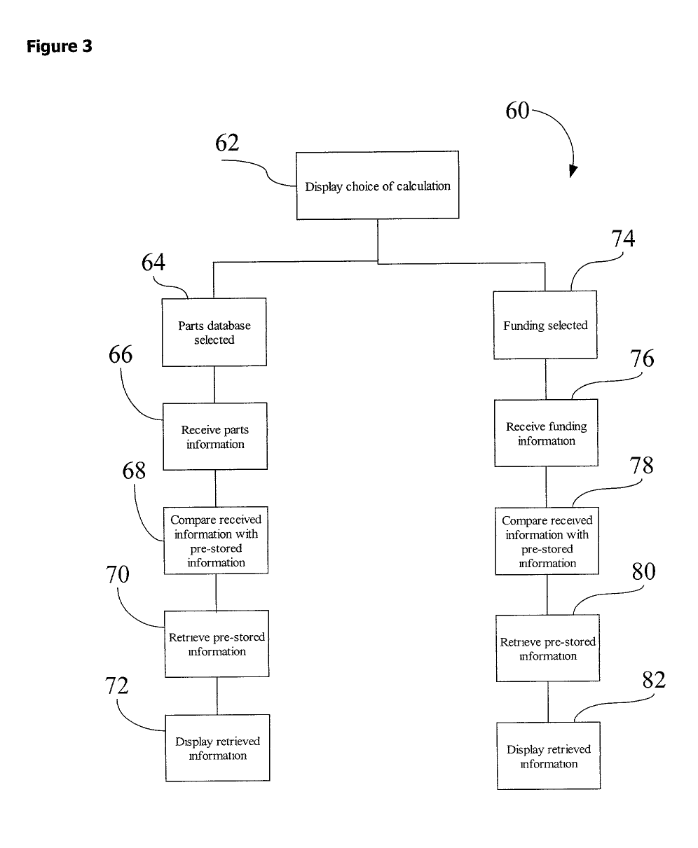

FIG. 3 is a flow diagram 60 for a web-based method for tracking and disseminating information regarding tools. In one embodiment, a tool calculation uses at least one of a part number, a purchase order, a funding request, a tool cost, a tool life expectancy, and a tool supplier. System 10 (shown in FIG. 1) displays 62 information regarding the selection of the desired calculation.

If a parts calculation is selected 64, system 10 then receives 66 parts calculation information from a user. In one embodiment, the user inputs the information into a device (such as device 14 shown in FIG. 1) that transmits the information to a server (such as server 12 shown in FIG. 1). The information relating to tools is received from the user via a graphical user interface as will be described in greater detail below.

Server 12 compares 68 the received information to pre-stored information accessible by server 12. In one embodiment, the pre-stored information is stored in a database that resides on server 12. In an alternative embodiment, the prestored information is stored in a database remote from server 12. The pre-stored information includes information about tools and funding requests involving tools. Server 12 compares the received information to the pre-stored information to determine if any tools contained in the pre-stored information satisfy the specifications submitted by the user. System 10 then retrieves 70 pre-stored parts information that matches the information entered by the user and displays 72 that pertaining to the identified pre-stored information.

If a funding calculation is selected 74, system 10 then receives 76 funding calculation information from a user. In one embodiment, the user inputs the information into a device (such as device 14 shown in FIG. 1) that transmits the information to a server (such as server 12 shown in FIG. 1). The information relating to tools is received from the user via a graphical user interface as will be described in greater detail below.

Server 12 compares 78 the received information to pre-stored information accessible by server 12. In one embodiment, the pre-stored information is stored in a database that resides on server 12. In an alternative embodiment, the pre-stored information is stored in a database remote from server 12. The pre-stored information includes information about tools and funding requests involving tools. Server 12 compares the received information to the pre-stored information to determine if any tools contained in the pre-stored information satisfy the specifications submitted by the user. System 10 then retrieves 80 pre-stored parts information that matches the information entered by the user and displays 82 that pertaining to the identified pre-stored information.

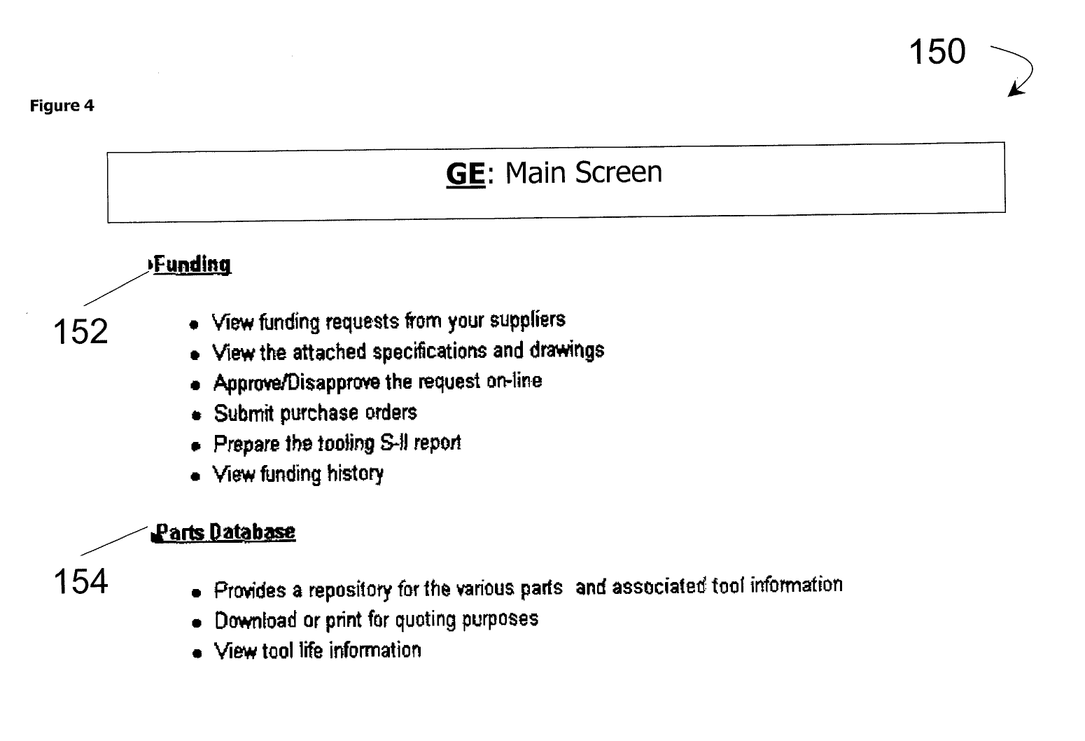

FIGS. 4 through 62 detail navigation through an exemplary web-site linked to system 10 (shown in FIG. 1) via device 14 (shown in FIG. 1) and server 12 (shown in FIG. 1). FIG. 4 shows an exemplary embodiment of a Main Screen page, as depicted in screen shot 150, which includes a Funding link 152 and a Parts Database link 154. Selection to the Funding link 152 allows the user to view funding requests from suppliers, view attached specifications and drawings, approve or disapprove funding requests online, submit purchase orders to suppliers, prepare the tooling S-II report, and viewed funding history. Selection of Parts Database link 154 provides the user with a repository for information concerning parts and associated tool information, as well as to download or print information for quoting purposes, and to view tool life information.

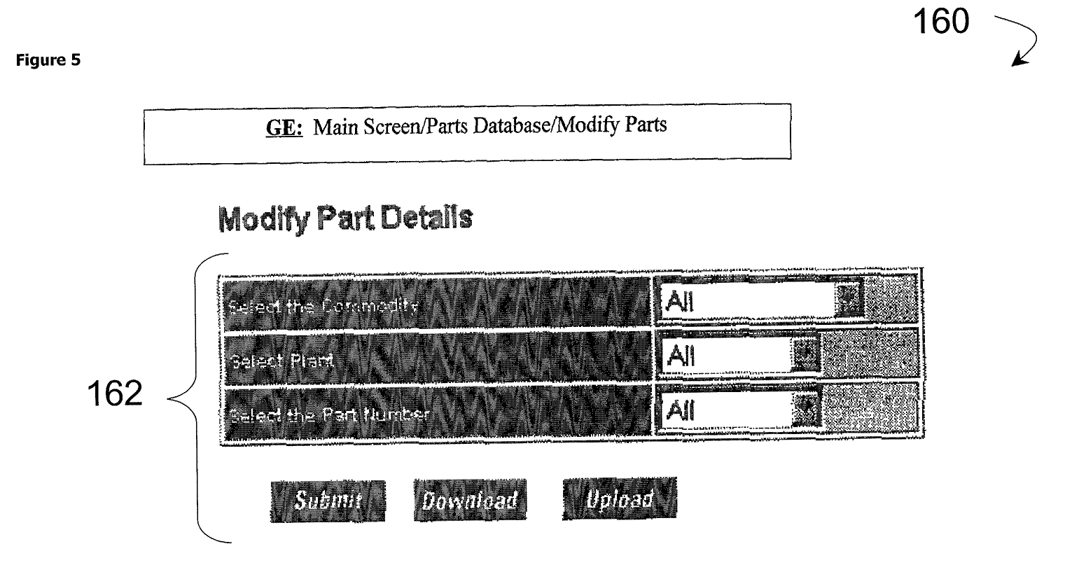

FIG. 5 shows an exemplary embodiment of a Main Screen /Parts Database/Modify Parts page, as depicted in screen shot 160 that includes a Modify Part Details display area 162 that includes pull down menus allowing selection a supplier's name and the part number of a part. Display area 162 further includes radio buttons to permit a supplier's name and part number information specified to be submitted to server 12 (shown in FIG. 1), downloaded from server 12, or uploaded to server 12.

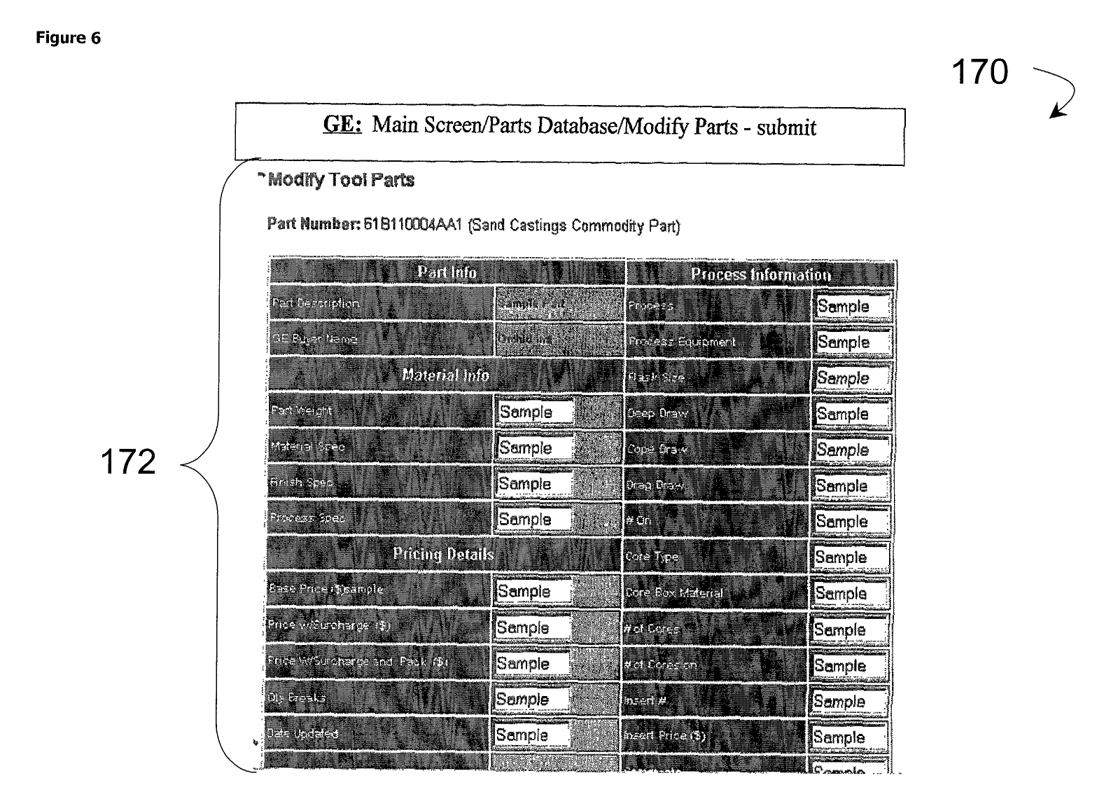

FIG. 6 shows an exemplary embodiment of a Main Screen/Parts Database/Modify Parts—Submit page as depicted in screen shot 170, which includes a display area 172 for displaying information about a part that has been selected. In an exemplary embodiment such information includes a part number, part description, buyer's name, information about the material such as part weight, material specification, specification, and process specification. Display area 172 includes pricing details such as base price, price with surcharge, price with surcharge and packing costs, quantity breaks, and the date updated. Display area 172 further includes process information, such as the process used to produce the tool part, the process equipment used, the flask size, deep draw, cope draw, drag draw, core type, core box material, number of cores, insert number, insert price, and comments.

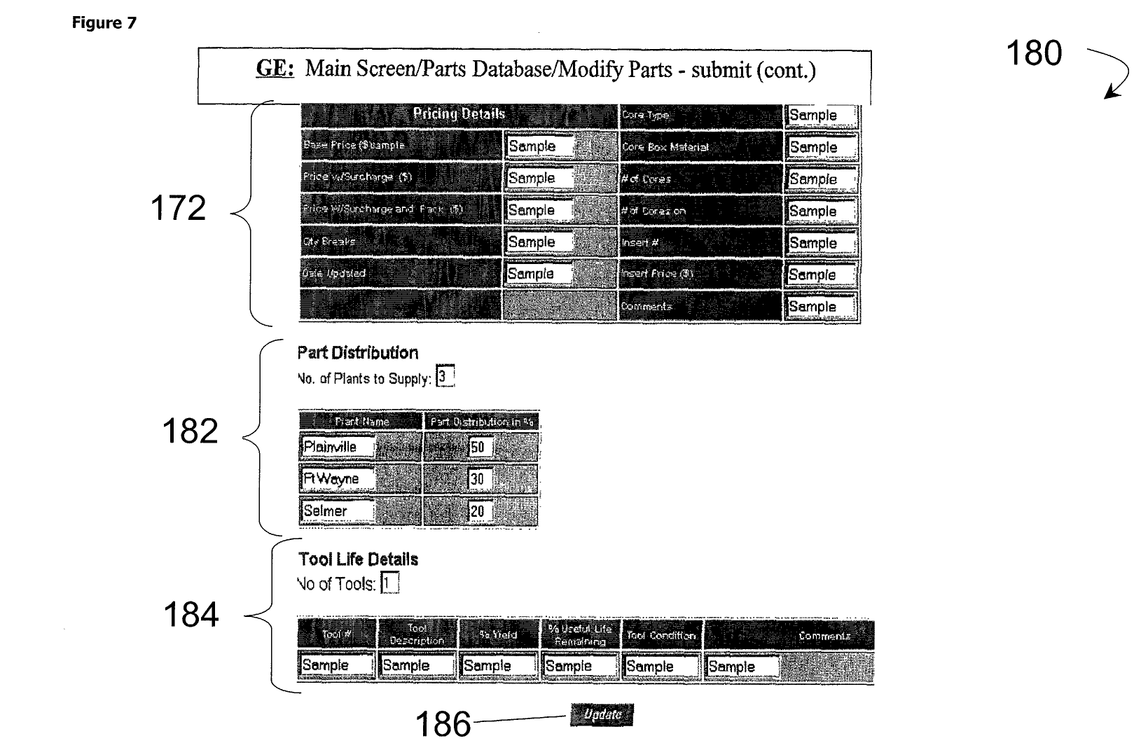

FIG. 7 shows the continuation of the Main Screen/Parts Database/Modify Parts—Submit page in screen shot 180. Screen shot 180 includes display area 182 providing information on the part distribution, that is the distribution of manufacture between various plants or factories. Display area 184 shows tool life details, specifically displaying the tool number, tool description, percent yield, percent useful life remaining, tool condition, and any comments. Screen shot 180 also includes Update link 186 for transmission of the responses to server 12 (shown in FIG. 1).

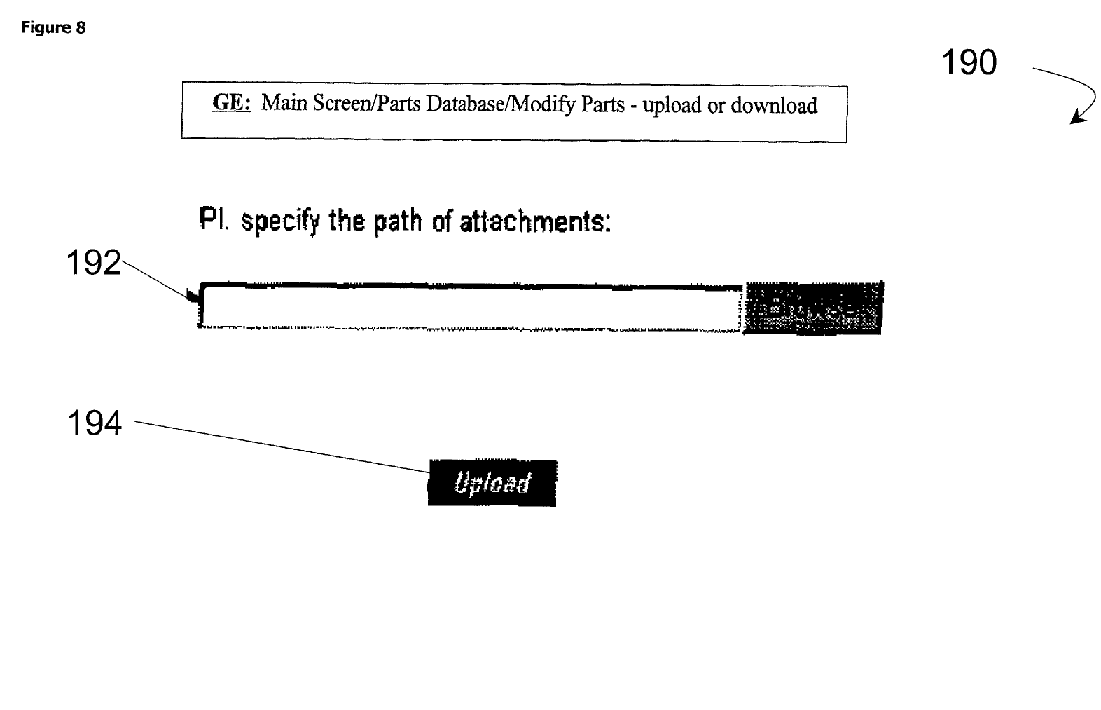

FIG. 8 shows an exemplary embodiment of a Main Screen/Parts Database/Modify Parts—Upload or Download page as depicted in screen shot 190, which includes a field 192 in which the path of any attachments can be specified, and Upload radio button 194 for transmission of the responses to server 12 (shown in FIG. 1).

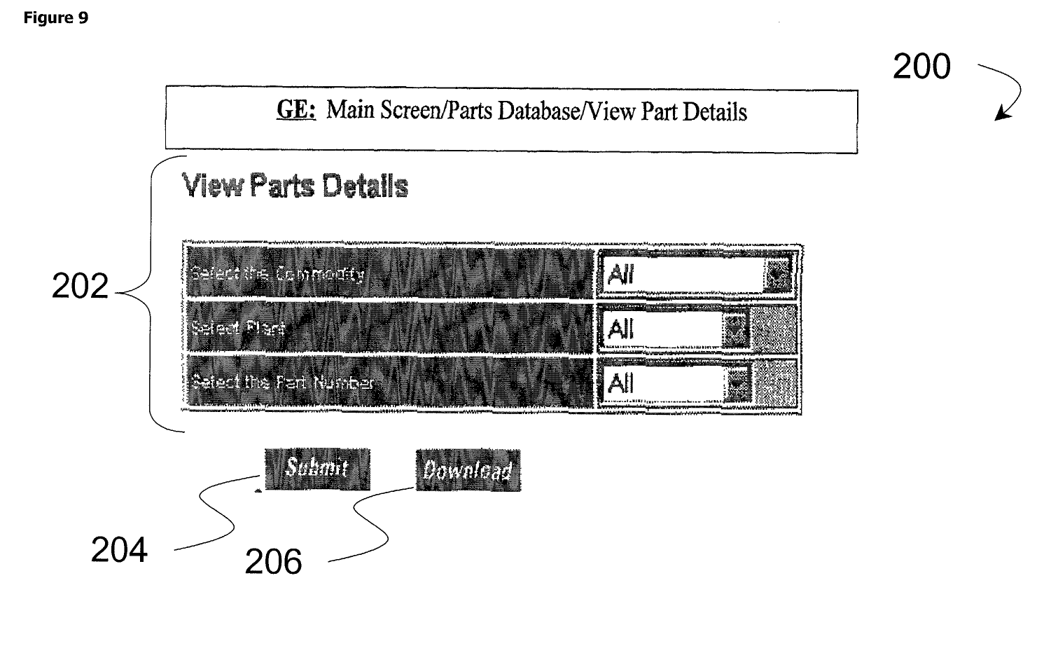

FIG. 9 shows an exemplary embodiment of a Main Screen/Parts Database/View Part Details page in screen shot 200, which includes a View Parts Details display area 202 that displays pull down menus allowing selection of the commodity, plant, and part number desired. Screen shot 200 also includes a Submit radio button 204 and a Download radio button 206, whereby information can be submitted to or downloaded from server 12.

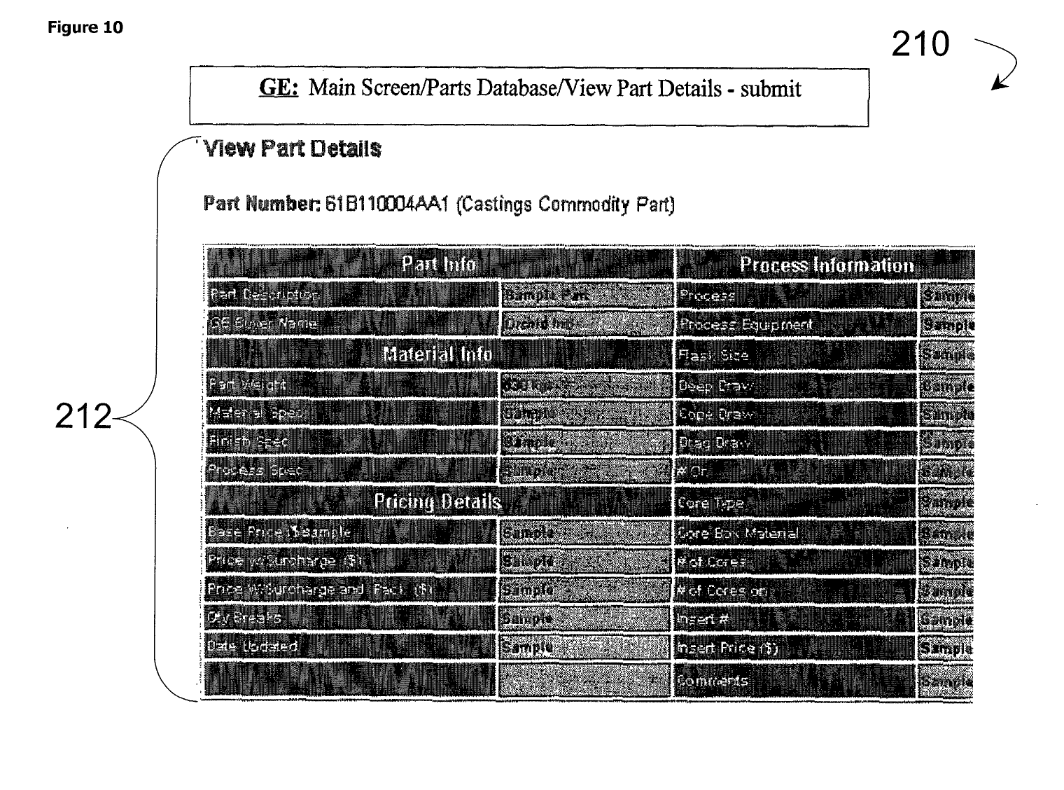

FIG. 10 shows an exemplary embodiment of a Main Screen/Parts Database/View Part Details—Submit page depicted in screen shot 210, which includes a display area 212 that displays information about the part, including the description and the name of the buyer, information about the material, such as part weight, material specification, finish specification, and process specification. Display area 212 optionally shows pricing details, such as base price, price with surcharge, price with surcharge and packing, quantity breaks, and date updated. Display area 212 also shows process information such as a process used to produce the part, a process equipment used, the flask size, deep draw, cope draw, drag draw, core type, core box material, number of cores, the insert number, the insert price, and comments.

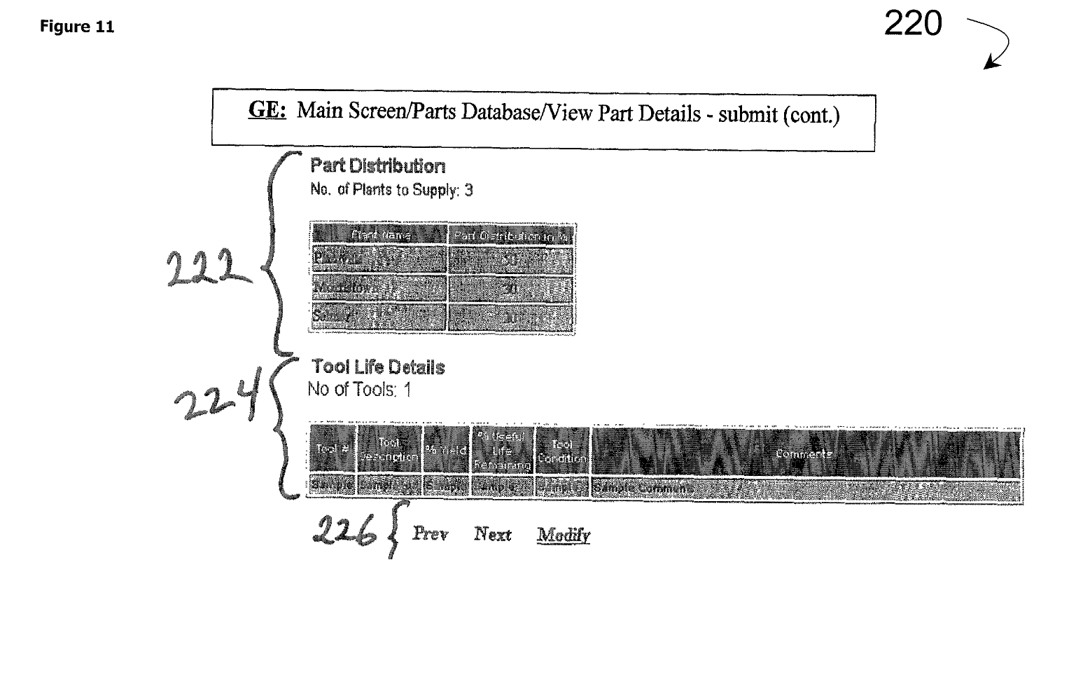

FIG. 11 is a continuation of the Main Screen/Parts Database/View Part Details—Submit page as depicted in screen shot 220, which continues screen shot 210 in showing a Part Distribution display area 222 displaying the distribution of manufacture between various plants. Screen shot 220 further includes a Tool Life Details display area 224 that displays information about the tool number, tool description, percent yield, percent useful life remaining in the tool, the condition of the tool, and any comments. Screen shot 220 also includes a display area 226 that provides links that permit navigation to the previous screen, the next screen, or a provision for modifying the present screen by transmitting information to server 12.

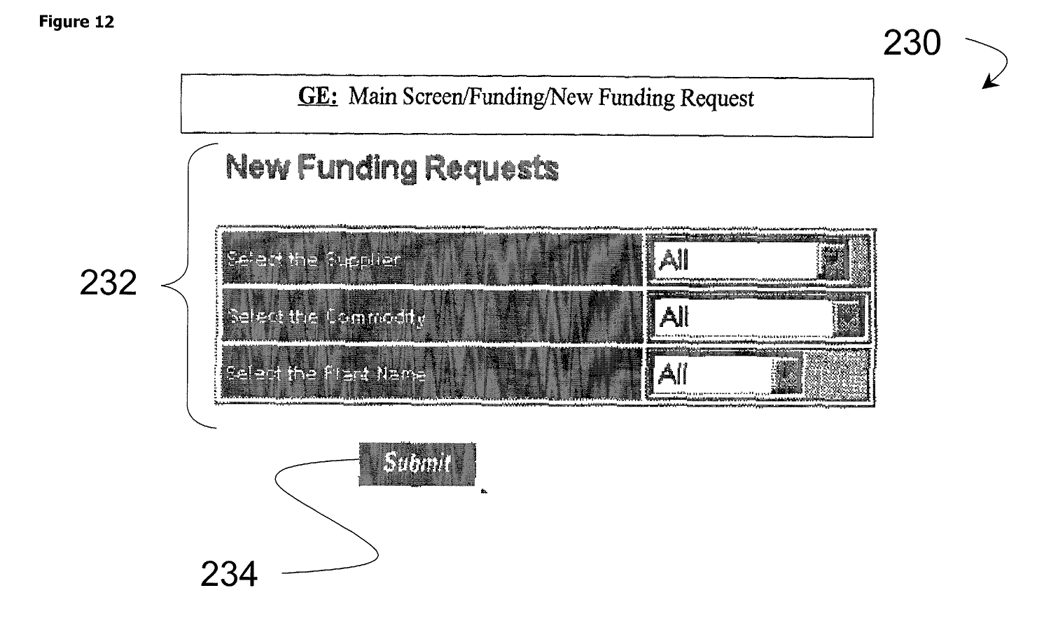

FIG. 12 shows an exemplary embodiment of a Main Screen/Funding/New Funding Request page in screen shot 230, which includes a New Funding Requests display area 232 where the supplier, the commodity, and the plant name can be selected from pull down menus. Screen shot 230 further includes a Submit radio button 234 for transmitting information selected in display area 232 to server 12.

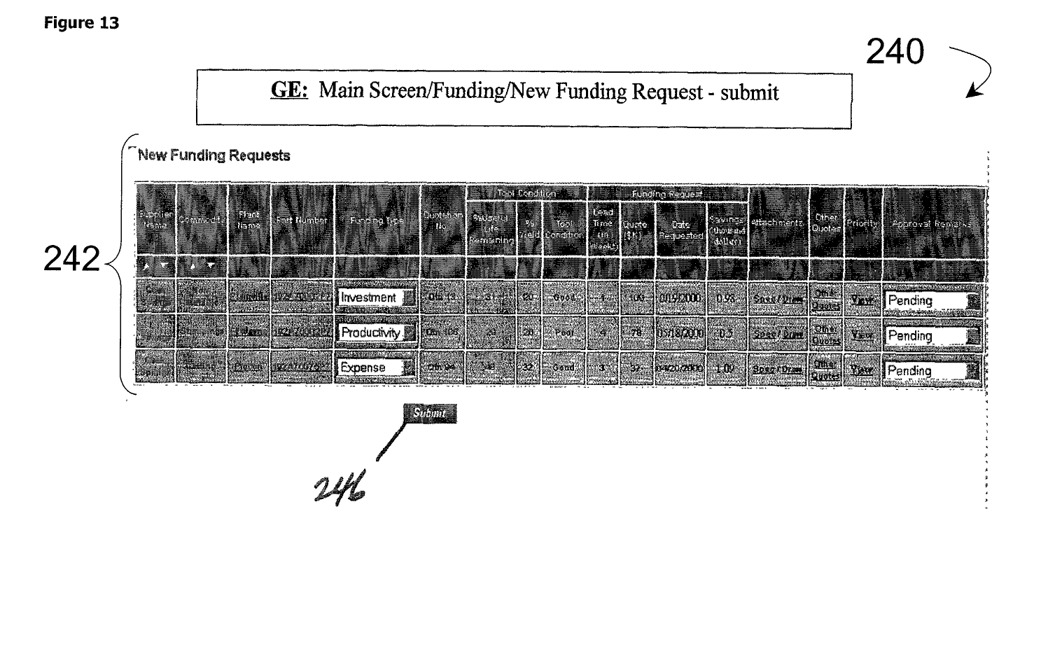

FIG. 13 shows an exemplary embodiment of a Main Screen/Funding/New Funding Request—submit page, as depicted in screen shot 240. Screen shot 240 includes a New Funding Requests display area 242 that displays information about the supplier name, commodity, plant name, part number, funding type, quotation number, tool condition, funding request parameters, any attachments, other quotes, priority, and remarks concerning approval. Screen shot 240 also includes a Submit radio button 246 for transmitting responses entered in display area 242 to server 12.

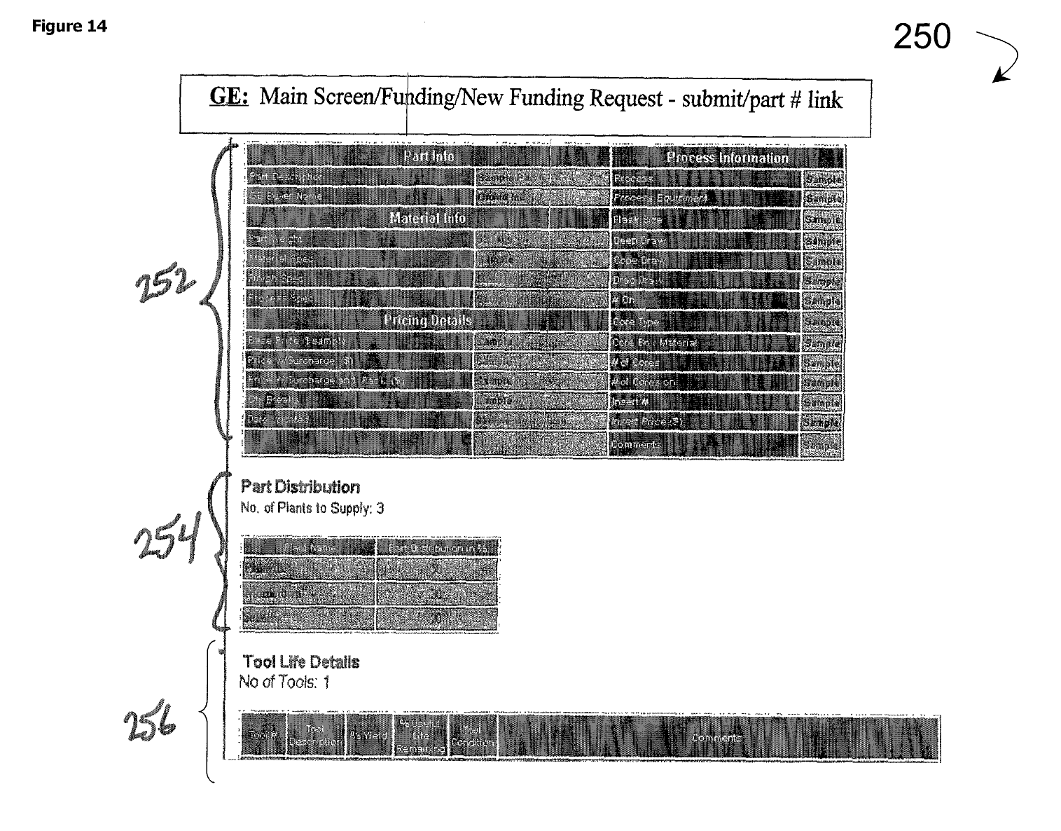

FIG. 14 shows an exemplary embodiment of a Main Screen/Funding/New Funding Request—submit/part # link page, as depicted in screen shot 250. Screen shot 250 includes a display area 252 that displays information about the part, such as its description, buyer name, weight, material, finish, process, and price. Screen shot 250 also includes a Part Distribution display area 254 that displays the distribution of manufacture of the part between various plants, and a Tool Life Details display area 256 that displays the tool number, description, percent yield, present useful life remaining, tool condition, and comments.

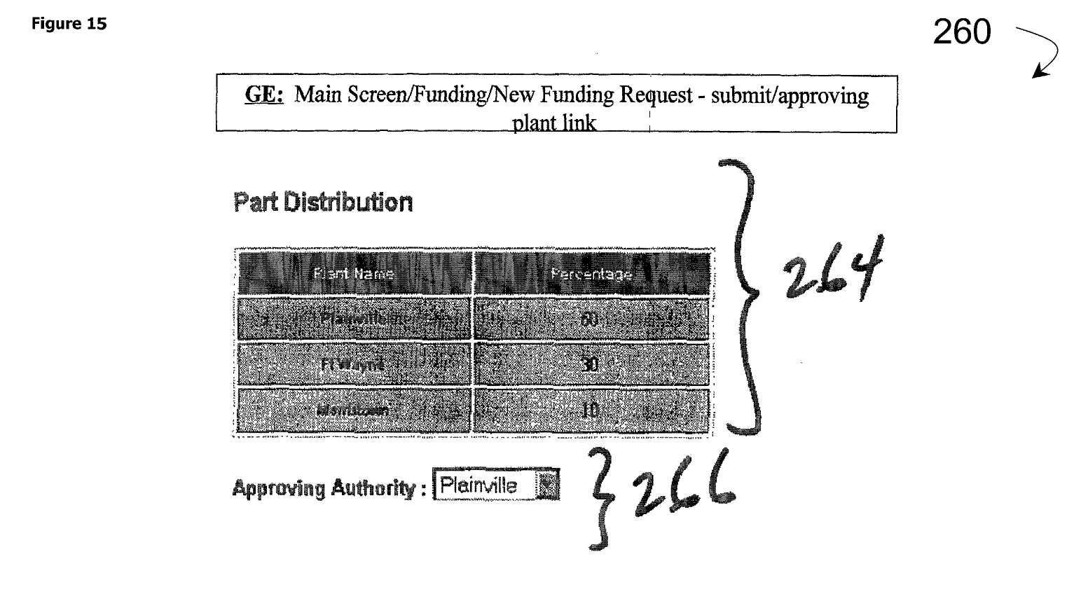

FIG. 15 shows an exemplary embodiment of a Main Screen/Funding/New Funding Request—submit/approving plant link page, as depicted in screen shot 260, which includes a Part Distribution display area 264 that displays the distribution of manufacture of the part between various plants, and a display area 266 that displays a pull down menu where the approving authority can be selected.

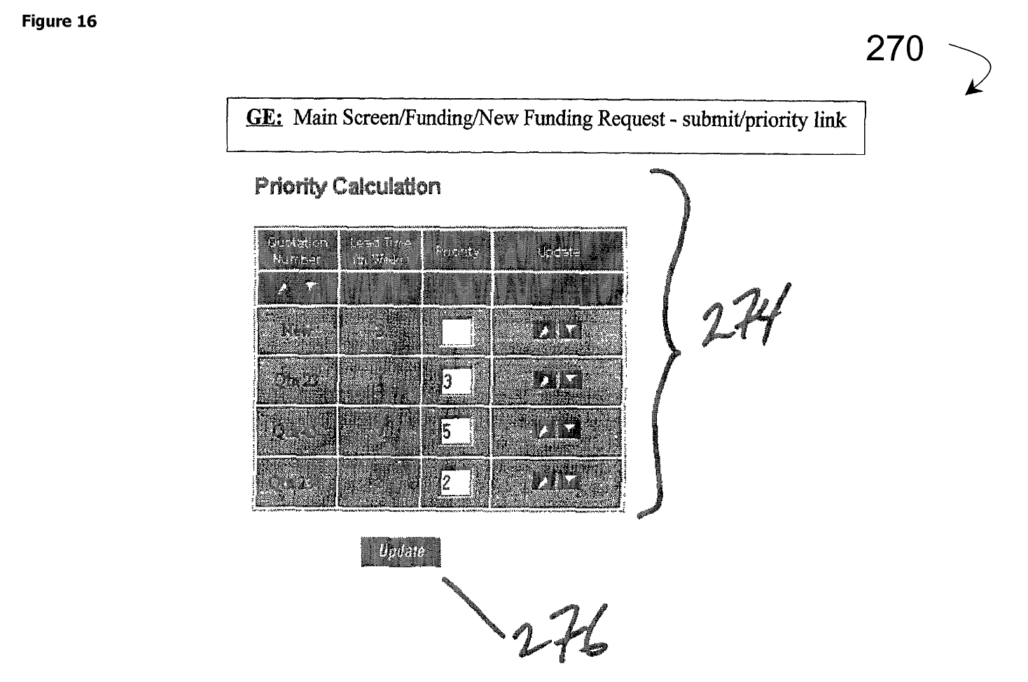

FIG. 16 shows an exemplary embodiment of a Main Screen/Funding /New Funding Request—submit/priority link page, as depicted in screen shot 270. Screen shot 270 includes a Priority Calculation display area 274 where the priority of the part purchase can be specified. Screen shot 270 also includes an Update radio button 276, selection of which transmits the amended priority information to server 12.

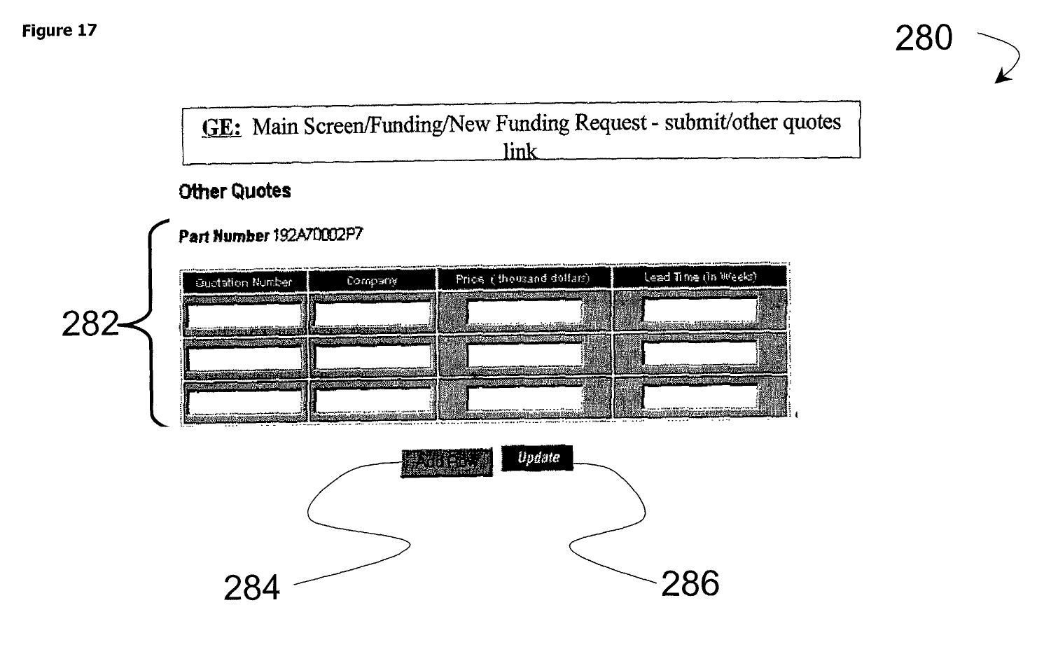

FIG. 17 shows an exemplary embodiment of a Main Screen/Funding/New Funding Request—submit/other quotes link page, as depicted in screen shot 280, which includes an Other Quotes display area 282 where other quotes for the specified part can be displayed, specifically including quotation number, company, price, and lead time. Screen shot 280 includes an Add Row radio button 284, selection of which allows insertion of further rows in display area 284, and also an Update radio button 286, selection of which transmits updated quotation information to server 12.

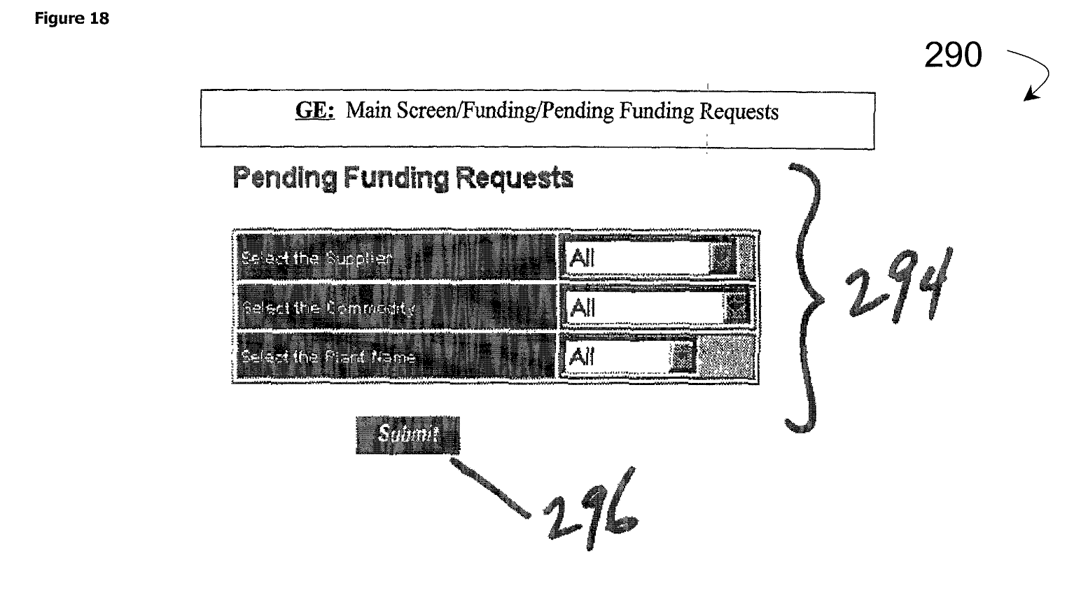

FIG. 18 shows an exemplary embodiment of a Main Screen/Funding/Pending Funding Requests page, as depicted in screen shot 290, which includes a Pending Funding Requests display area 294, which displays pull down menus for selection of the supplier, commodity, and plant name. Screen shot 290 further includes a Submit radio button 296 for transmission of the information chosen in Pending Funding Requests display area 294 to be sent to server 12.

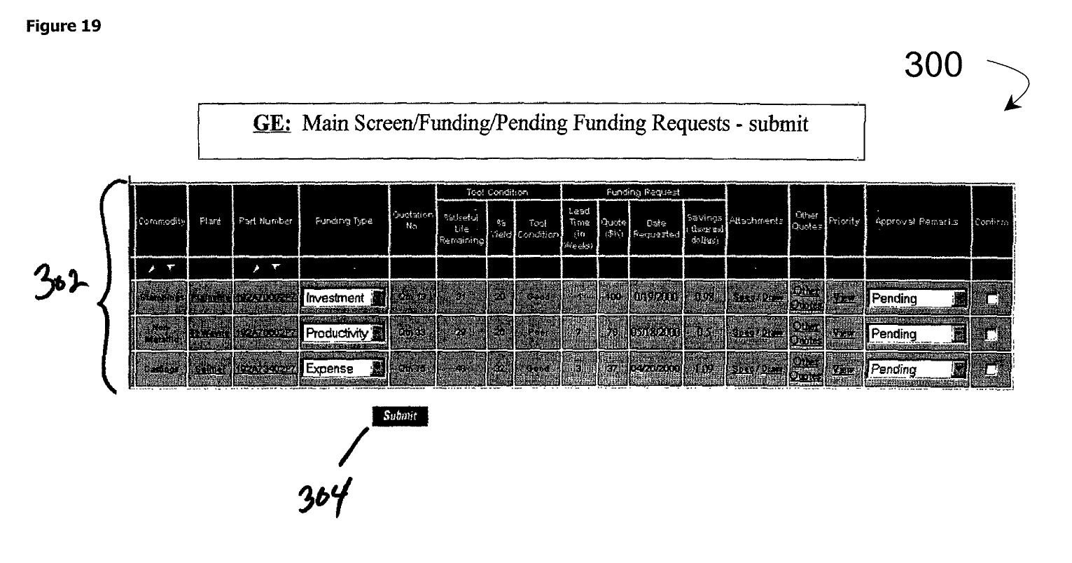

FIG. 19 shows an exemplary embodiment of a Main Screen Size Funding/Pending Funding Requests—submit page, as depicted in screen shot 300. Screen shot 300 includes a Pending Funding Requests display area 302 that displays information pertinent to the tool, including the commodity, plant, part number, funding type, quotation number, tool condition, funding request, attachments, other quotes, priority, remarks concerning approval, and a check box for confirmation. Screen shot 300 further includes a Submit radio button 304 for transmission of information chosen in display area 302 to server 12.

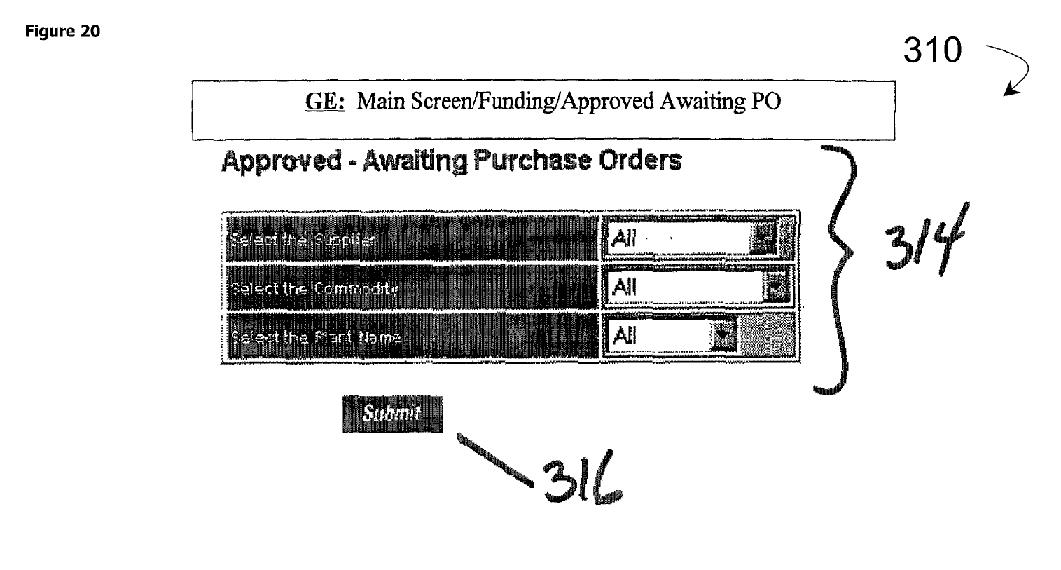

FIG. 20 shows an exemplary embodiment of the Main Screen/Funding/Approved Awaiting PO page, as depicted in screen shot 310, which includes an Approved-Awaiting Purchase Orders display area 314, where the supplier, commodity, and plant name can be specified through use of pull down menus. Screen shot 310 further includes a Submit radio link 316 for transmission of information selected in display area 314 to server 12.

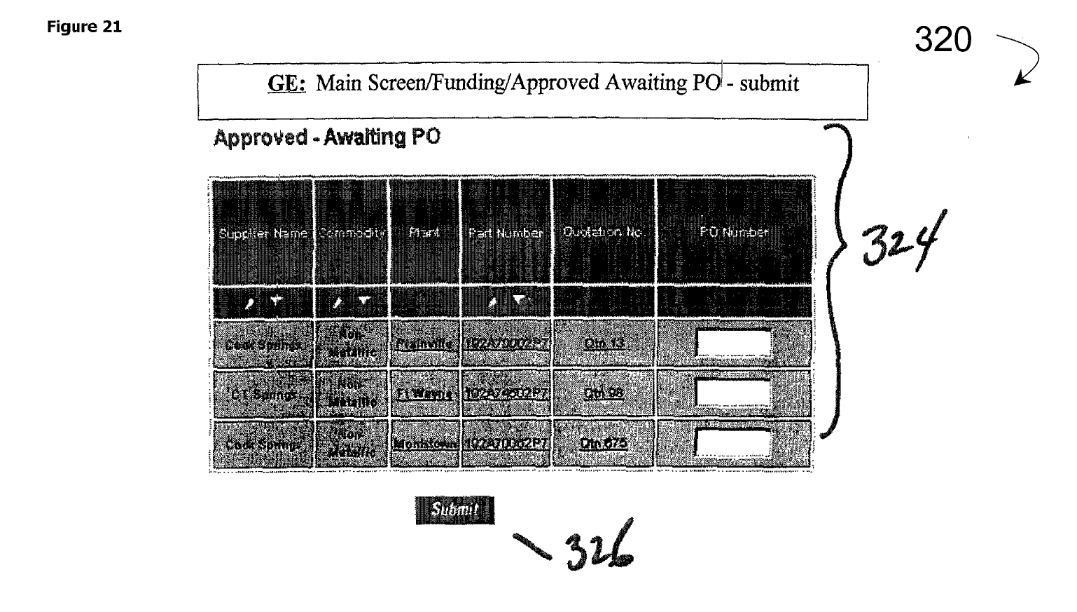

FIG. 21 shows an exemplary embodiment of a Main Screen/Funding/Approved Awaiting PO—submit page, as depicted in a screen shot 320. Screen shot 320 includes an Approved-Awaiting PO display area 324, where the supplier, commodity, plant, part number, quotation number are all displayed, and the purchase order number can be entered. Screen shot 320 further includes a Submit radio link 326 for transmission of information selected in display area 324 to server 12.

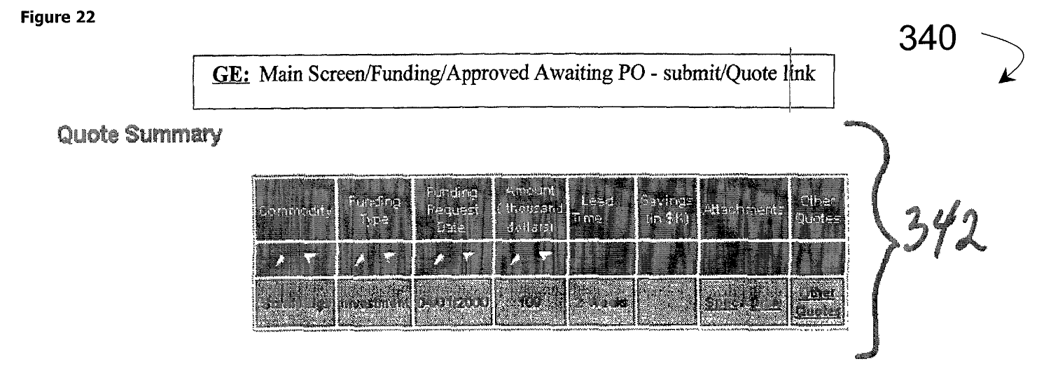

FIG. 22 shows an exemplary embodiment of a Main Screen Size Funding/Approved Awaiting PO—submit/quote link page, as depicted in screen shot 340. Screen shot 340 includes a Quote Summary display area 342, that displays information about the commodity, funding type, funding request date, amount, lead time, savings, attachments, and links to other quotes.

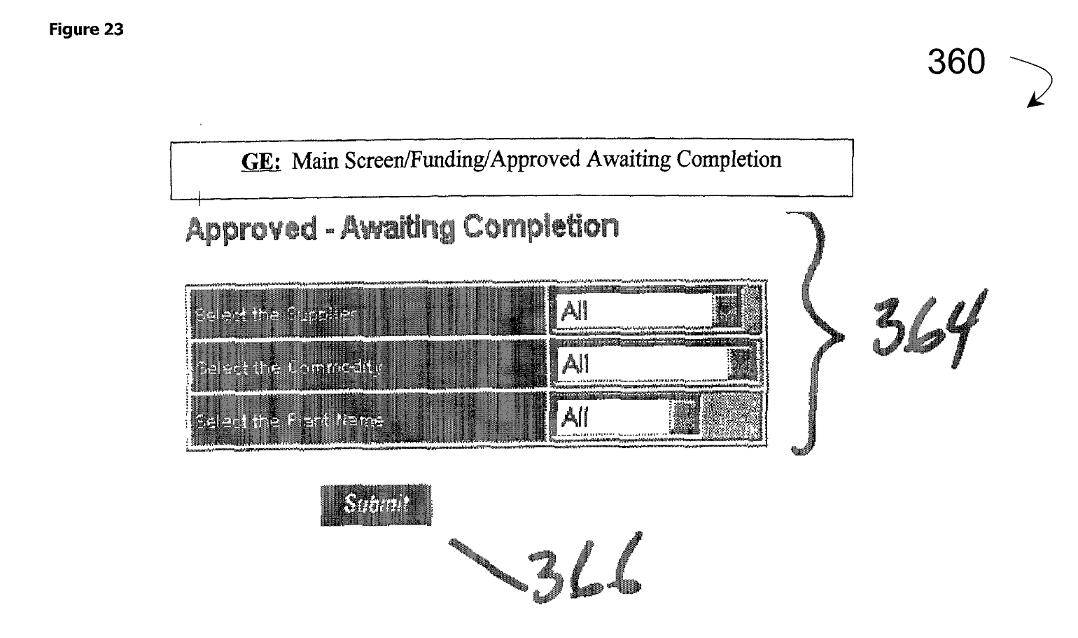

FIG. 23 shows an exemplary embodiment of the Main Screen/Funding/Approved Awaiting Completion page, as depicted in screen shot 360. Screen shot 360 includes an Approved—Awaiting Completion display area 364 that allows selection to the supplier, commodity, and plant name through use of pull down menus, and a Submit radio button 366 that transmits the information to the server 12.

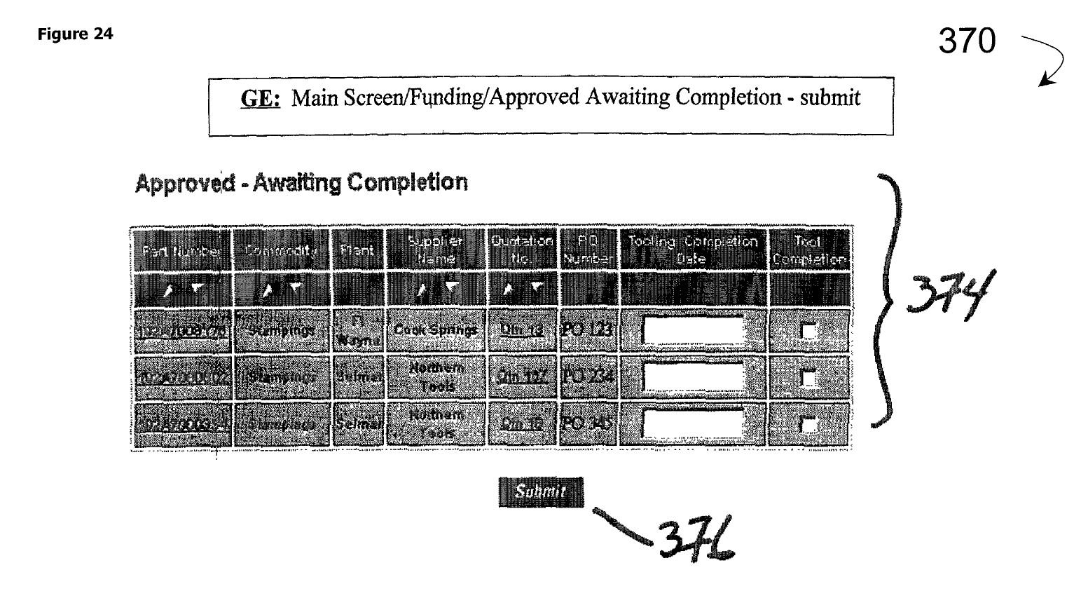

FIG. 24 shows an exemplary embodiment of a Main Screen/Funding/Approved Awaiting Completion—submit page, as depicted in screen shot 370. Screen shot 370 includes an Approved-Awaiting Completion display area 374 that displays information relating to part number, commodity, plant, supplier name, quotation number, purchase order number, and allows entry of information about tooling completion date and a tool completion check box. Screen shot 370 further includes a Submit radio buttons 376, by which the information entered can be transmitted to server 12.

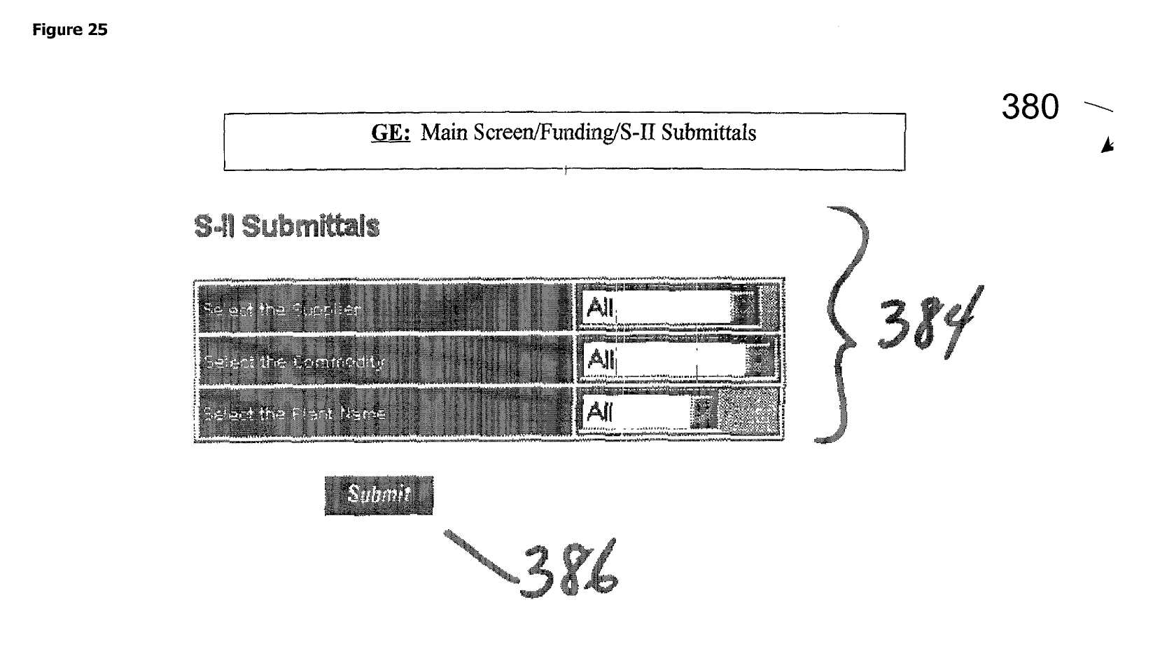

FIG. 25 shows an exemplary embodiment of the Main Screen/Funding/S-II Submittals page, as depicted in screen shot 380. Screen shot 380 includes an S-II Submittals display area 384 that allows selection of the supplier, commodity, and plant name through use of pull down menus. Screen shot 380 further includes a Submit radio button 386, by which the supplier, commodity, and plant name information can be transmitted to server 12.

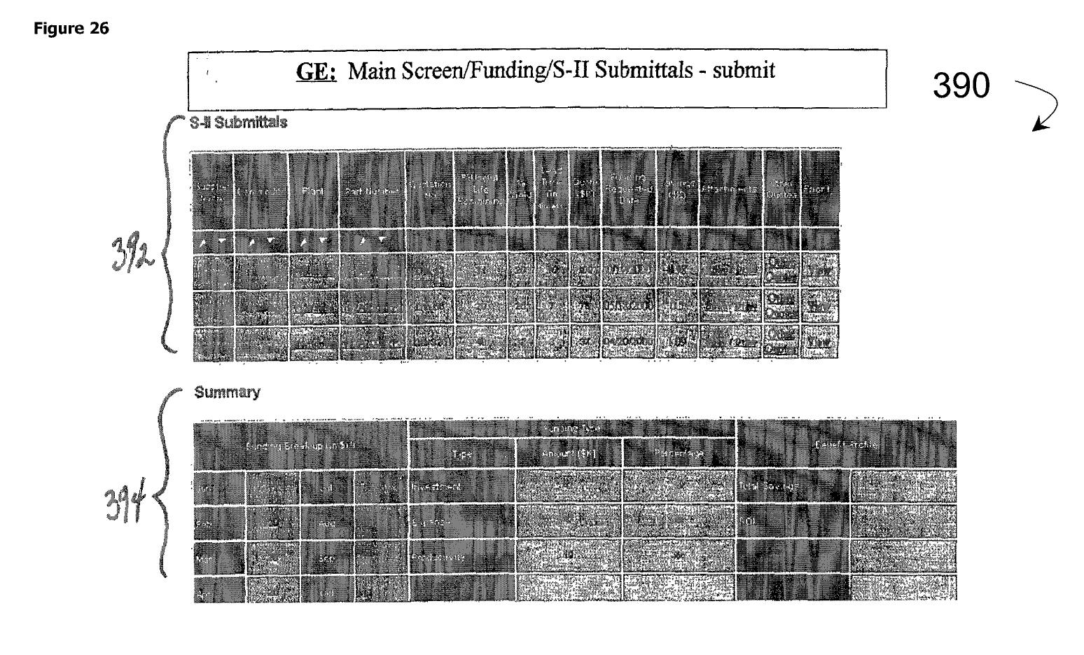

FIG. 26 shows an exemplary embodiment of a Main Screen/Funding/S-II Submittals—submit page, as depicted in screen shot 390. Screen shot 390 includes an S-II Submittals display area 392 that displays supplier name, commodity, plant, part number, quotation number, percent useful life remaining, percent yield, lead time, quote, funding requested, savings, attachments, other quotes, and priority. Screen shot 390 also includes a Summary display area 394 that displays funding breakup over the months of the year, funding type, whether investment, expense, or productivity, and benefit profile.

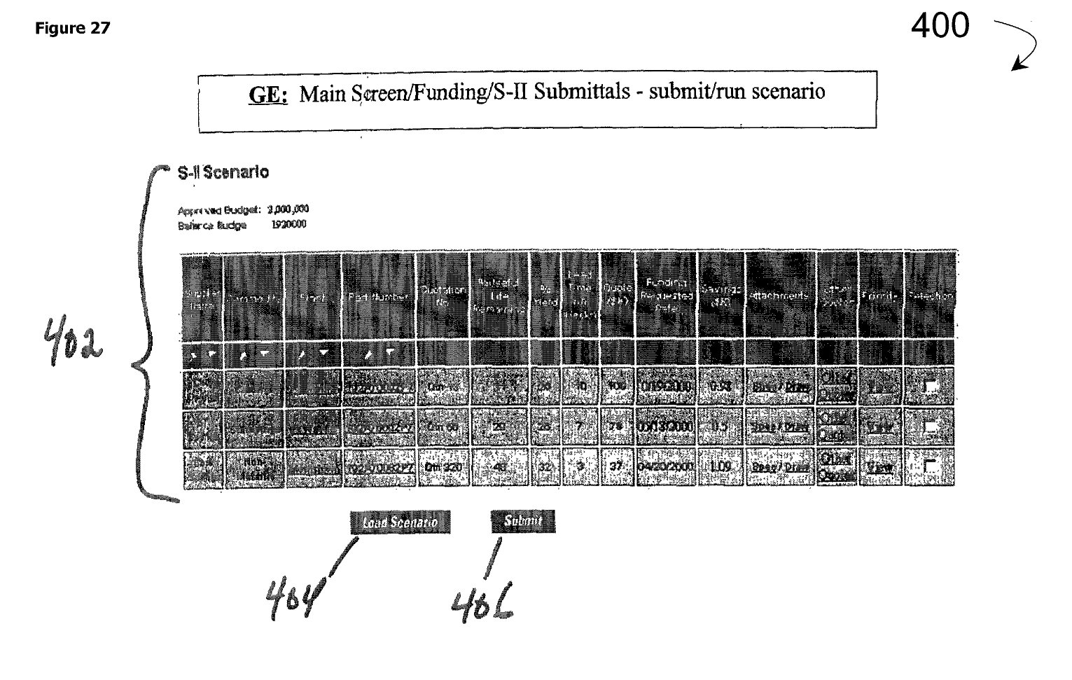

FIG. 27 shows an exemplary embodiment of a Main Screen/Funding/S-II Submittals—submit/run scenario page, as depicted in screen shot 400. S-II Scenario display area 402 shows supplier named, commodity, plant, part number, quotation number, percent useful life remaining, percent yield, lead time, quote, funding requested date, savings, attachments, other quotes, priority, and a check box for selection. Screen shot 400 further includes Load Scenario radio button 404, selection of which loads a scenario from server 12, and Submit radio button 406, selection of which transmits information to server 12.

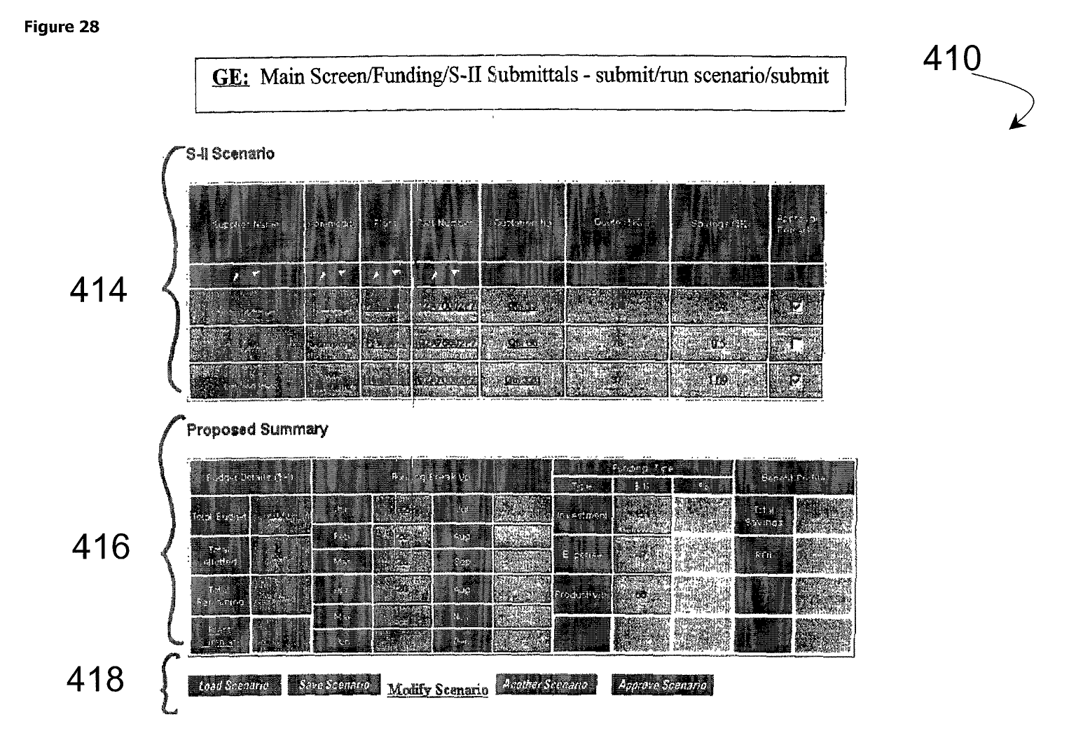

FIG. 28 shows an exemplary embodiment of a Main Screen/Funding/S-II Submittals-submit/run scenario/submit page, as depicted in screen shot 410. Screen shot 410 includes an S-II Scenario display area 414 that displays the supplier named, commodity, plant, part number, quotation number, quote, savings, and a check box to indicate the existence of any remarks concerning approval. Screen shot 410 further includes a Proposed Summary display area 416 that displays budget details, funding breakup over the year, funding type, whether investment, expense, or productivity, and benefit profile. Screen shot 410 still further includes a display area 418 that includes a Load Scenario radio button, a Save Scenario radio button, a Modify Scenario radio button, an Another Scenario radio button, and an Approve Scenario radio button.

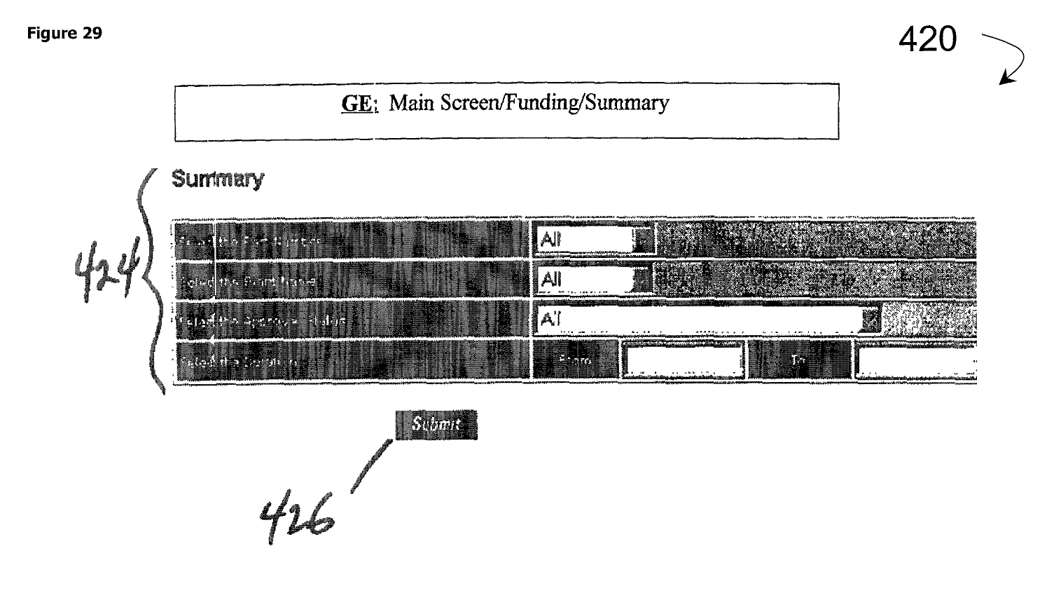

FIG. 29 shows an exemplary embodiment of the Main Screen/Funding/Summary page, as depicted in screen shot 420. Screen shot 420 includes a Summary display area 424 that provides pull down menus where the part number, plant name, and approval status of a tool can be selected, and as well as two entry fields where the duration can be entered. Information selected in the pull down menus and entered in the data entry fields can then be submitted for transmission to server 12 by selection of a Submit radio button 426.

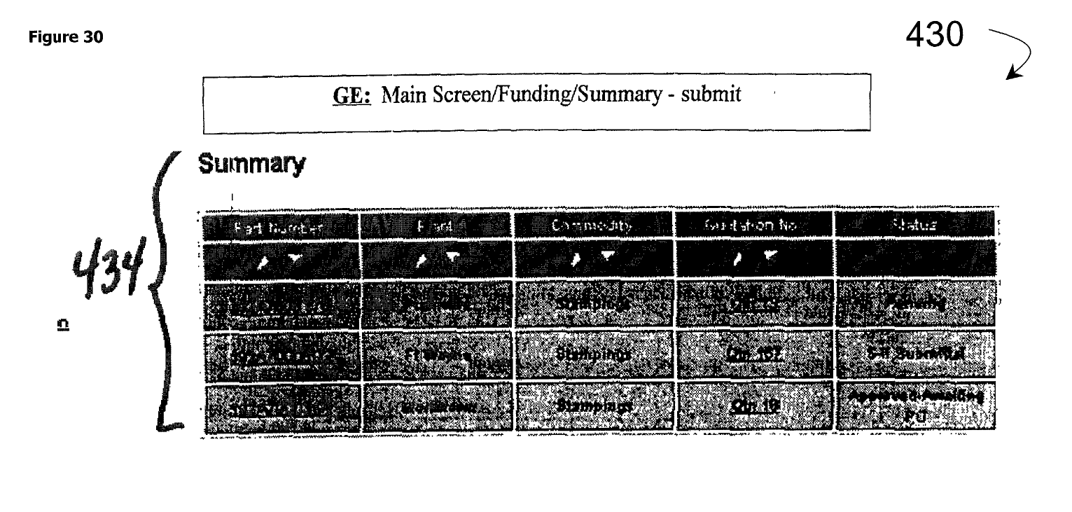

FIG. 30 shows an exemplary embodiment of a Main Screen Size Funding/Summary-submit page, as depicted in screen shot 430. Screen shot 430 includes a Summary display area 434 that shows part number, plant, commodity, quotation number, and status.

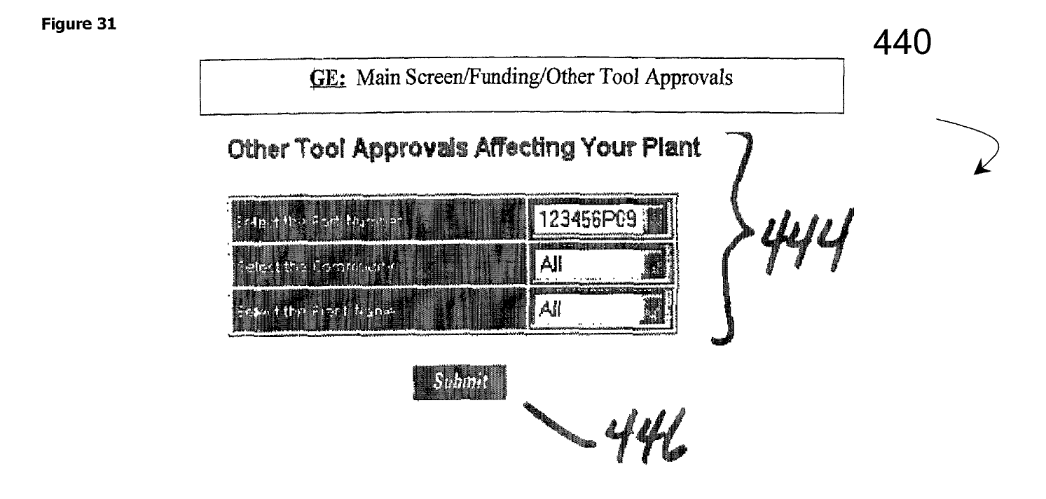

FIG. 31 shows an exemplary embodiment of the Main Screen/Funding/Other Tool Approvals page, as depicted in screen shot 440. Screen shot 440 includes an Other Tool Approvals Affecting Your Plant display area 444 that displays pull down menus where the part number, commodity, and plant name can each be selected. After selection of these items in display area 444, the information selected can be submitted for transmission to server 12 by selection of a Submit radio button 446.

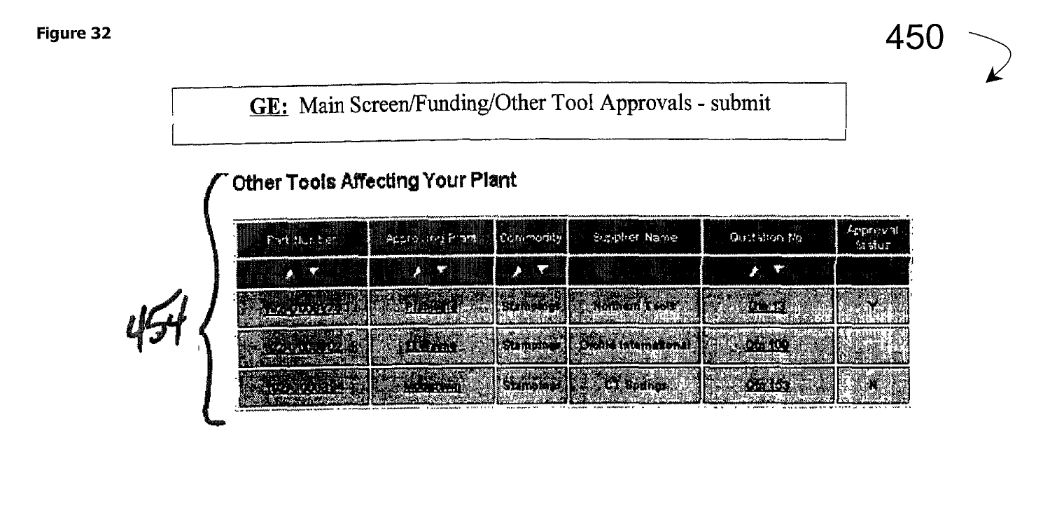

FIG. 32 shows an exemplary embodiment of a Main Screen/Funding/Other Tool Approvals-submit page, as depicted in screen shot 450. Screen shot 450 includes an Other Tools Affecting Your Plans display area 454 that displays part number, approving plant, commodity, supplier named, quotation number, and approval status.

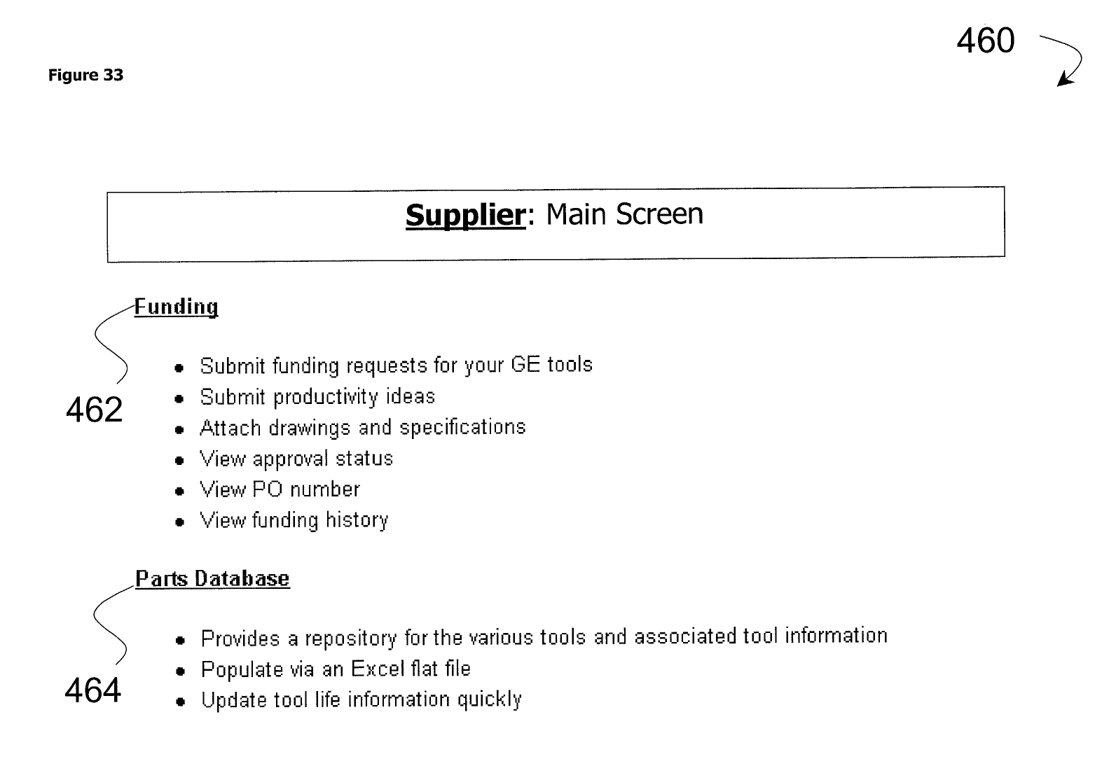

FIG. 33 shows an exemplary embodiment of a Supplier Main Screen, as depicted in screen shot 460. Screen shot 460 includes a Funding link 462 and a Parts Database link 464.

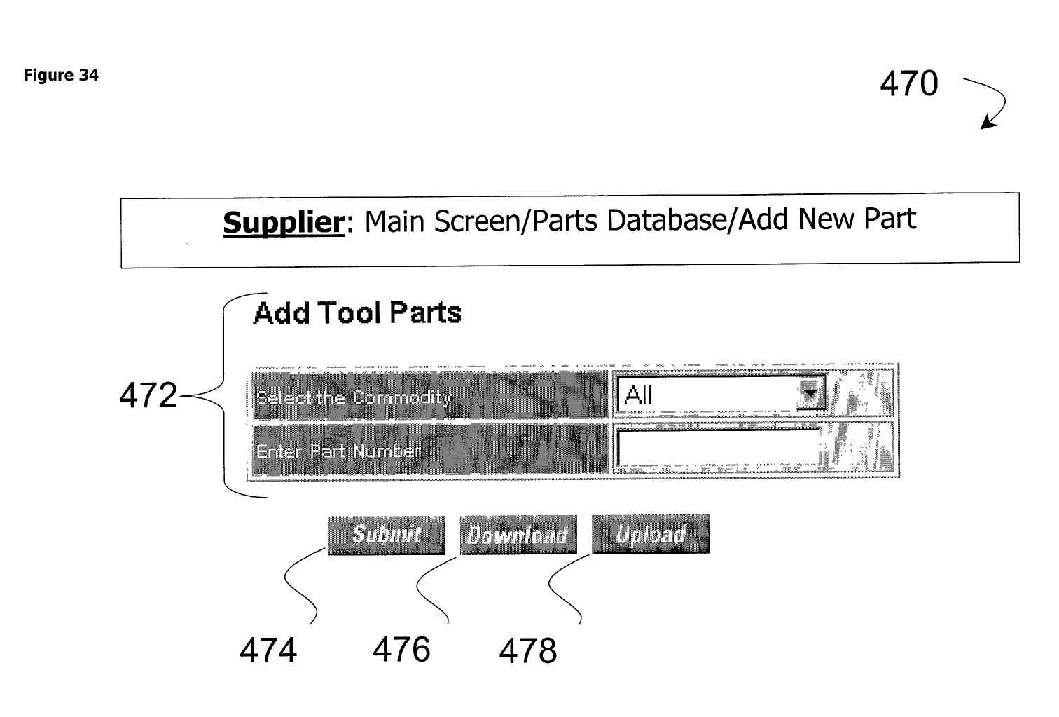

FIG. 34 shows an exemplary embodiment of a Supplier Main Screen/Parts Database/Add New Part page, as depicted in screen shot 470. Screen shot 470 includes an Add Tool Parts selection area 472 that in one embodiment includes pull down menus for selection of a commodity and a part number. Screen shot 470 also includes a Submit radio button 474, a Download radio button 476, and an Upload radio button 478.

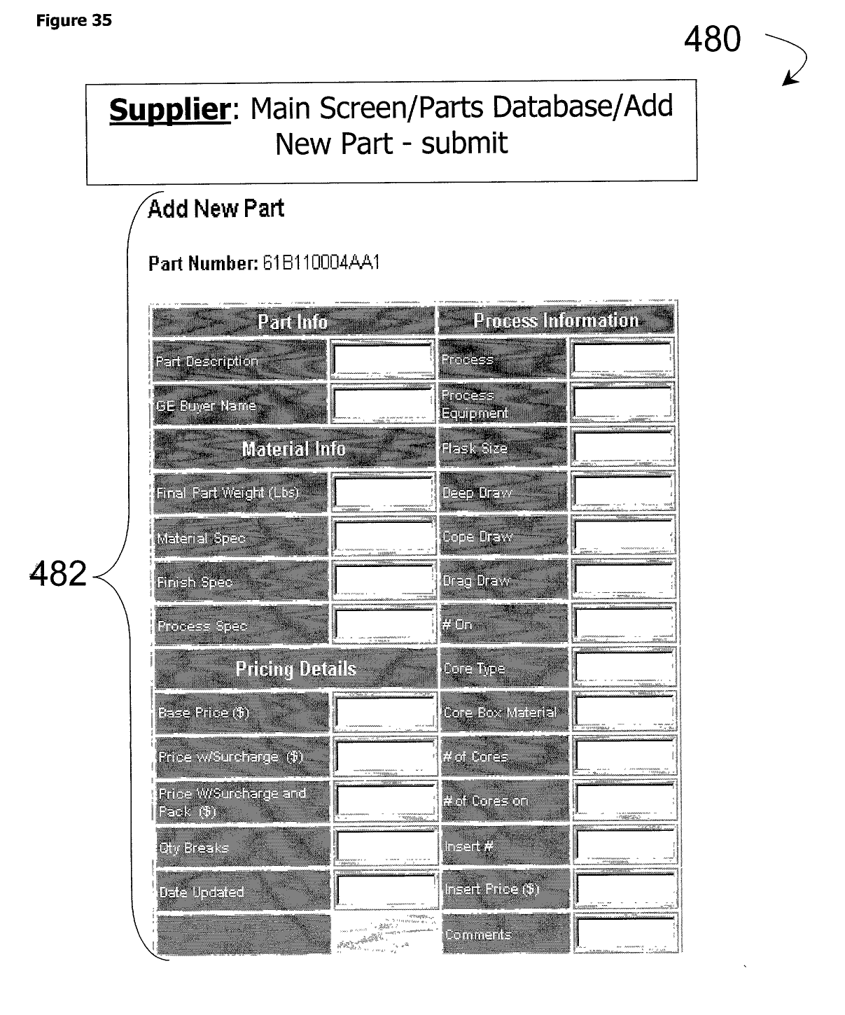

FIG. 35 shows an exemplary embodiment of a Supplier Main Screen/Parts Database/ Database/Add New Part—submit page, as depicted in screen shot 480. Screen shot 480 includes an Add New Part selection area 482 in which the user can specify information about a part, including one embodiment its description, its price, and details concerning its physical properties and a processed by which it is manufactured.

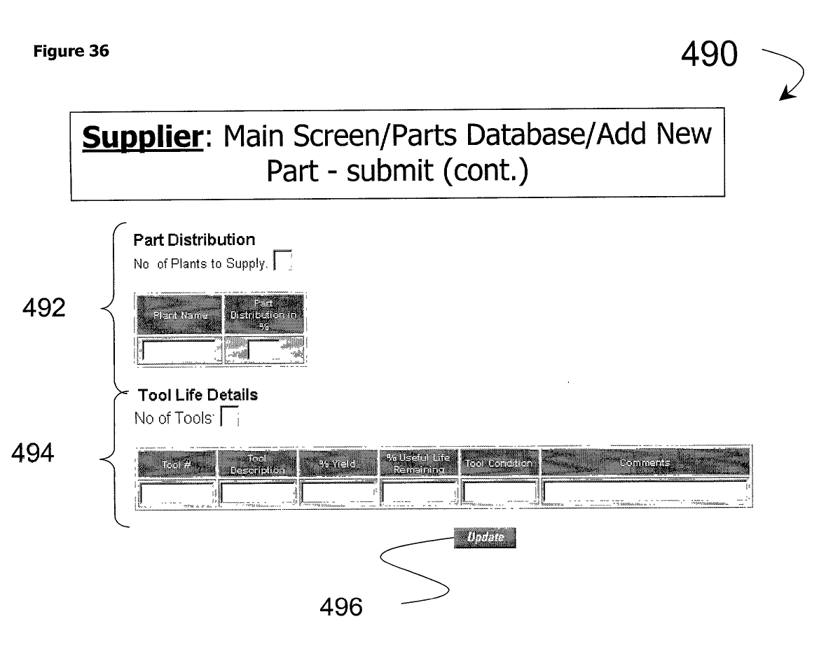

FIG. 36 is a continuation page of a Main Screen/Parts Database/Database/Add New Part—submit page, as depicted in screen shot 490. Screen shot 490 includes a Part Distribution selection area 492, wherein the user can specify the percentage of the manufactured parts are produced by which plant. Screen shot 490 also includes a Tool Life Details selection area 494 in which the user can specify a one embodiment the number of a tool, its description tool, its percent yield, its percent useful life remaining, its condition, and any comments. Screen shot 490 to further includes an Update radio button 496.

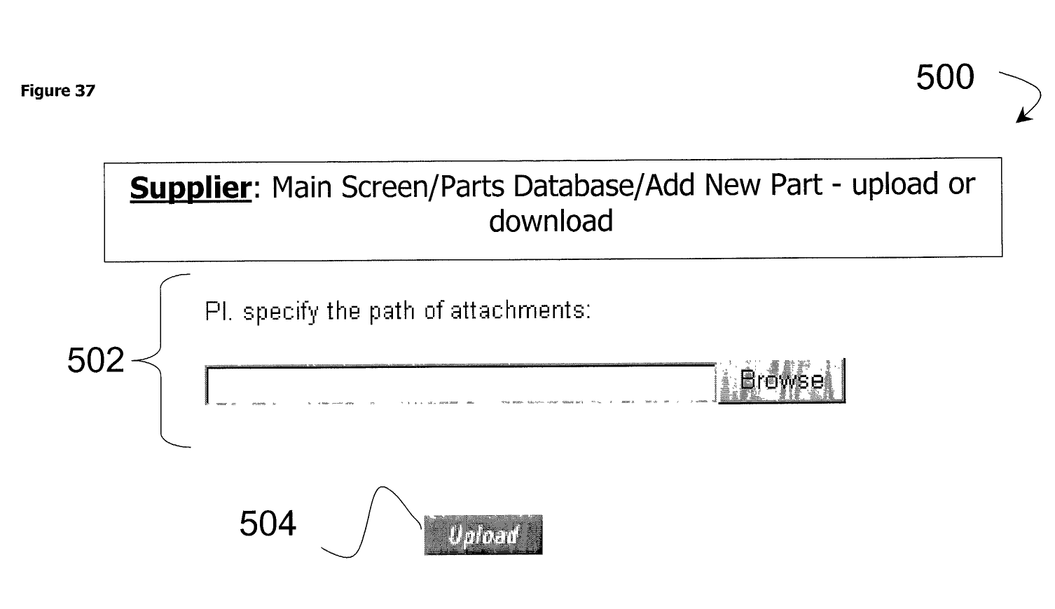

FIG. 37 shows an exemplary embodiment of a Supplier Main Screen/Parts Database/Add New Part—upload or download page, as depicted in screen shot 500. Screen shot 500 includes a Path of Attachments selection area 502, were the user can specify the path of any attachments to be uploaded to the parts database, and an Upload radio link 504.

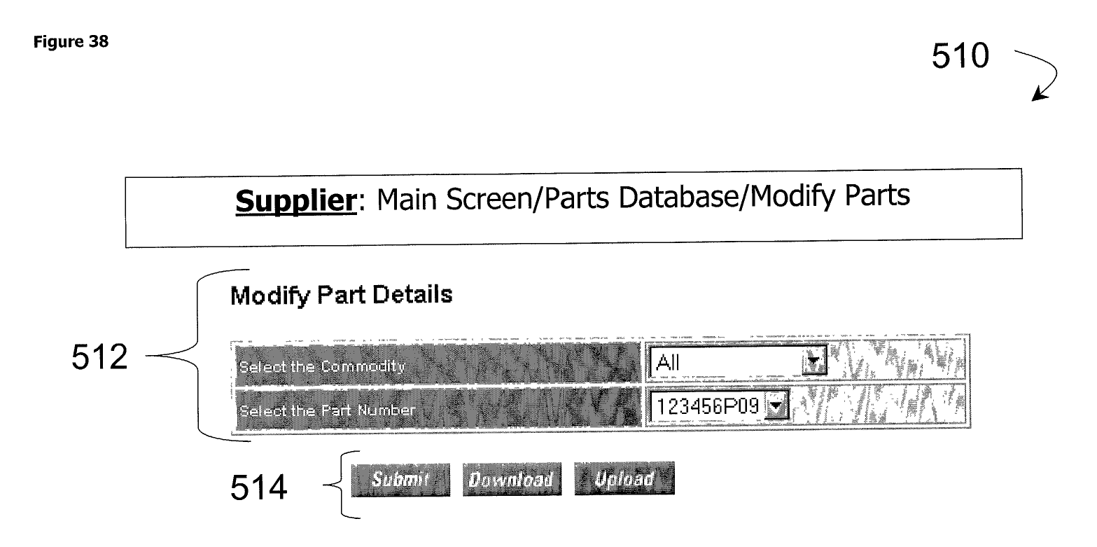

FIG. 38 shows an exemplary embodiment of a Supplier Main Screen/Parts Database/Modify Parts page, as depicted in screen shot 510. Screen shot 510 includes a Modify Part Details selection area 512 that includes pull down menus for specifying a commodity and a part number. Screen shot 510 also includes a set of Submit, Download, and Upload radio buttons 514.

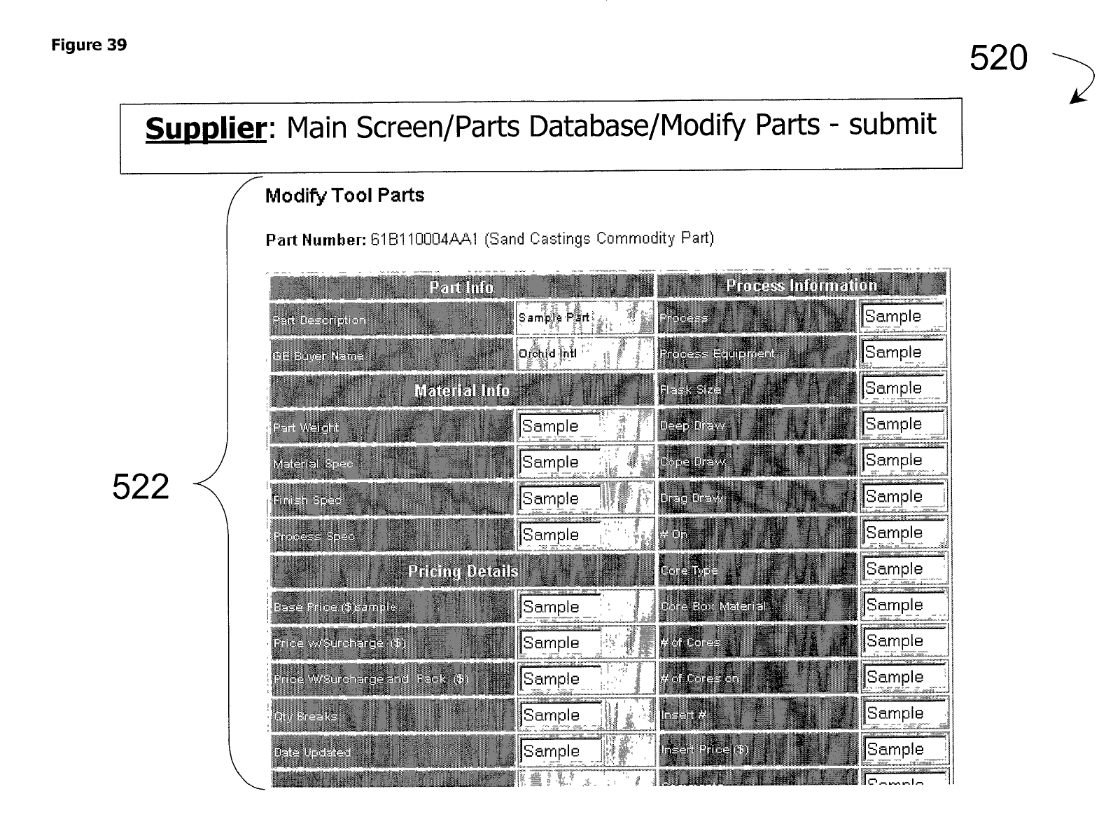

FIG. 39 shows an exemplary embodiment of a Supplier Main Screen/Parts Database/ Modify Parts—submit page, as depicted in screen shot 520. Screen shot 520 includes a Modify Tool Parts selection area 522 in which the user can specify information about a part, including one embodiment its description, its price, and details.

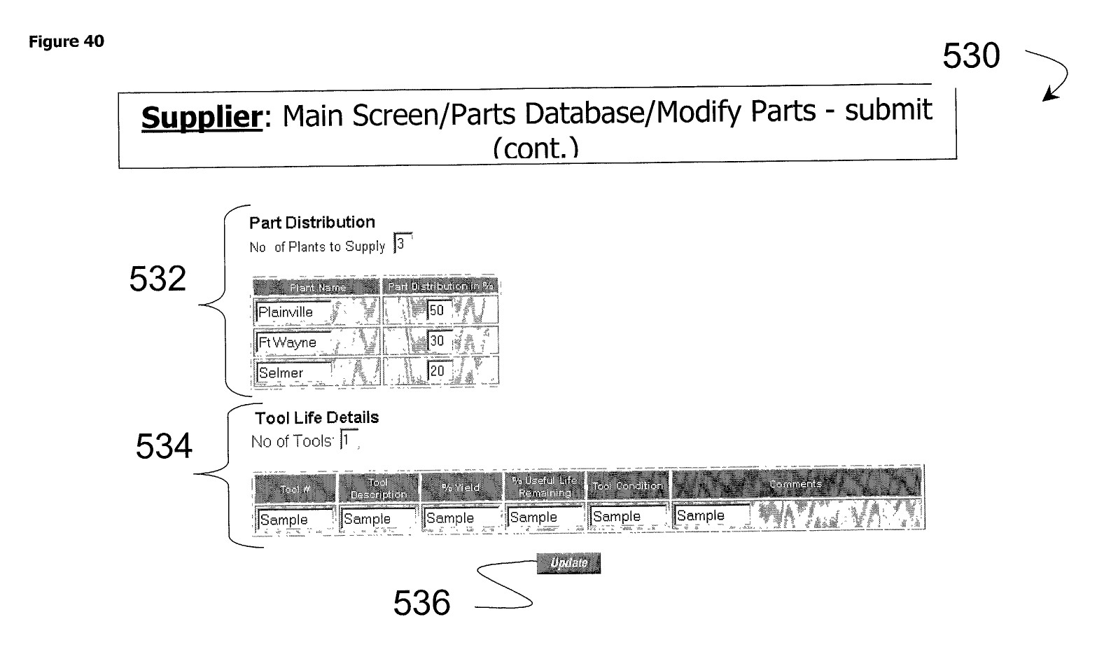

FIG. 40 is a continuation page of a Supplier Main Screen/Parts Database/Modify Parts—submit page, as depicted in screen shot 530. Screen shot 530 includes a Part Distribution selection area 532 in which the user can specify the distribution of manufacture of a part between different plants. Screen shot 530 also includes a Tool Life Details selection area 534 in which in one embodiment the user can specify the number of a tool, a description of a tool, and percent yield, the percent useful life remaining, the condition of the tool, and any comments. Screen shot 530 further includes an Update radio button 536.

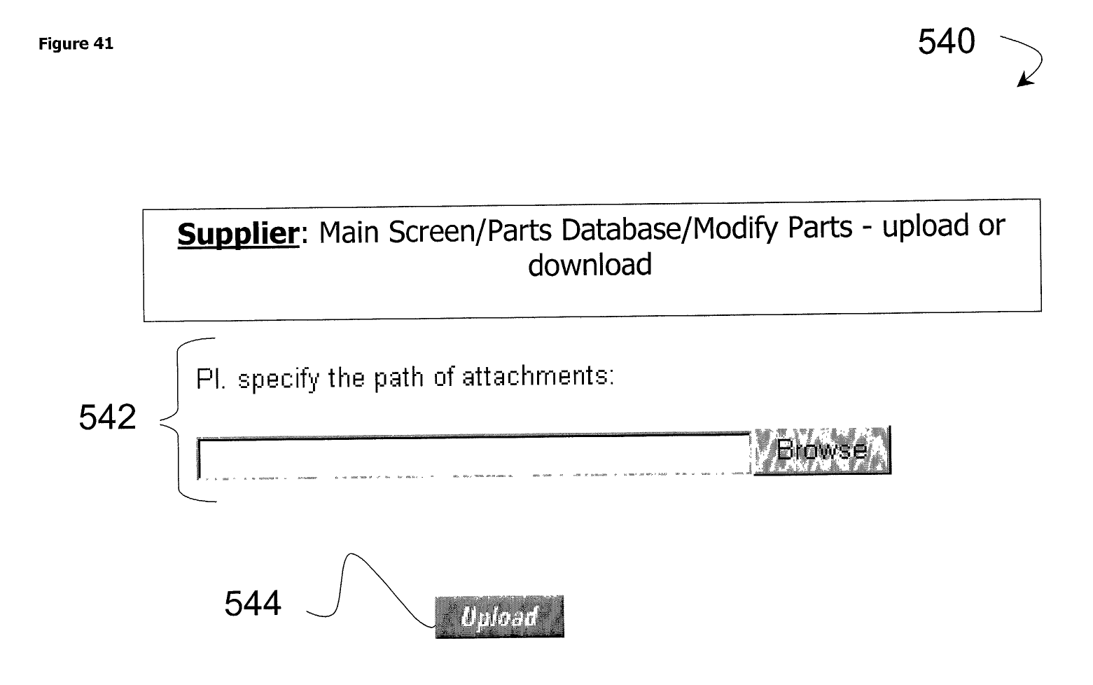

FIG. 41 shows an exemplary embodiment of a Supplier Main Screen/Parts Database/Modify Parts—upload or download page, as depicted in screen shot 540. Screen shot 540 includes a Path of Attachments selection area 542, were the user can specify the path of any attachments to be uploaded to the parts database, and an Upload radio link 544.

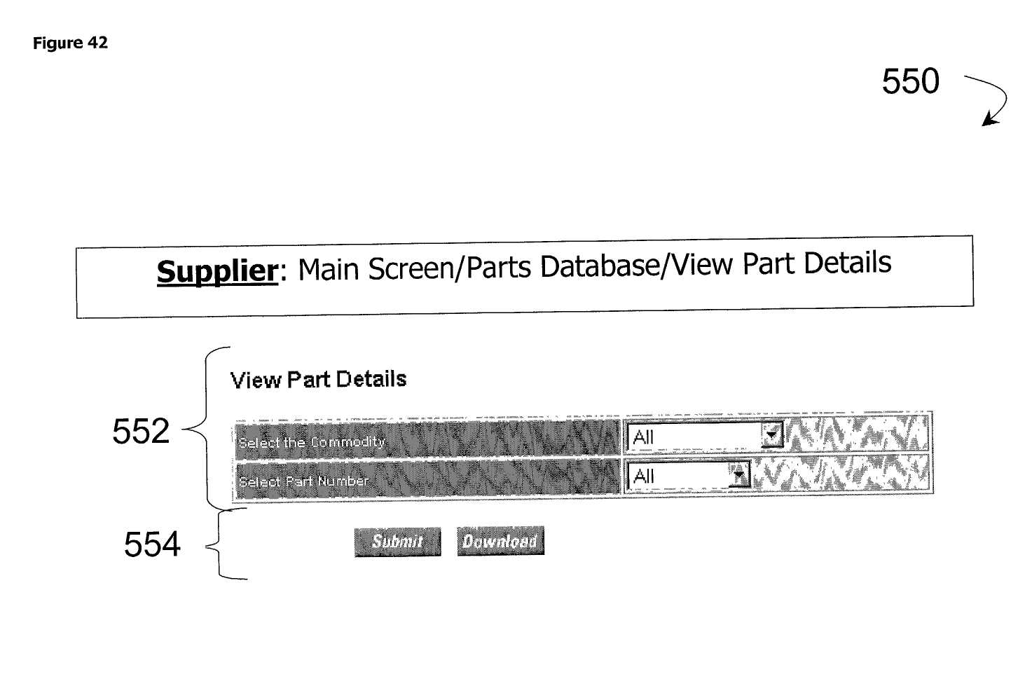

FIG. 42 shows an exemplary embodiment of a Supplier Main Screen/Parts Database/View Part Details page, as depicted in screen shot 550. Screen shot 550 includes a View Part Details selection area 552 in which the user can specify a commodity and a part number. Screen shot 550 also includes a set of Submit and Download radio buttons 554.

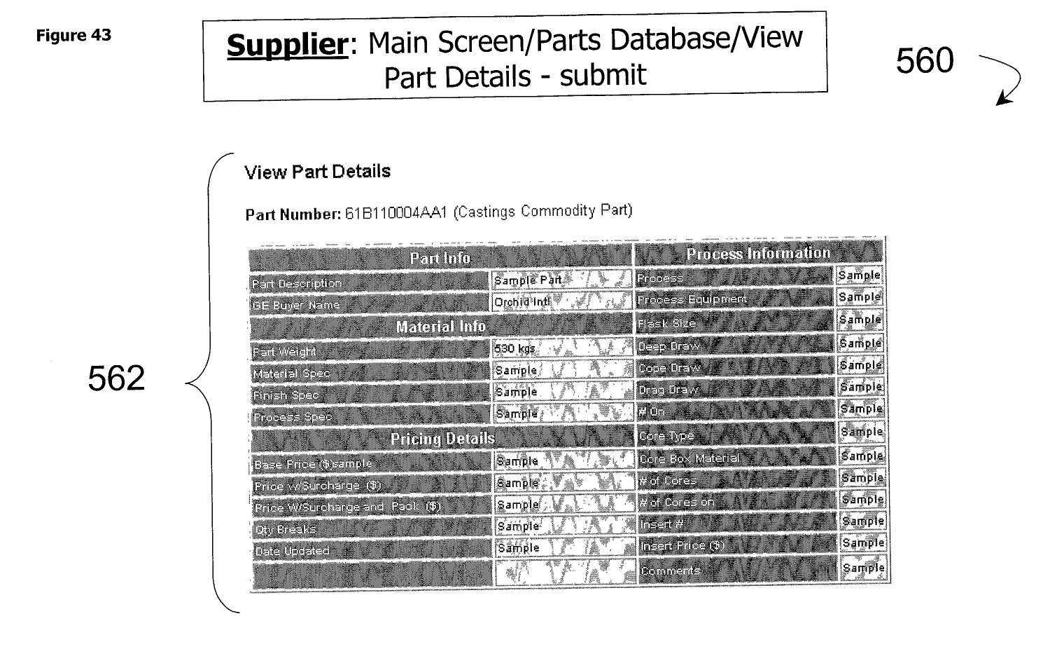

FIG. 43 shows an exemplary embodiment of a Supplier Main Screen/Parts Database/View Part Details—submit page, as depicted in screen shot 560. Screen shot 560 includes a View Part Details display area 562 that displays process information, such as the process used to produce the tool part, the process equipment used, the flask size, deep draw, cope draw, drag draw, core type, core box material, number of cores, insert number, insert price, and comments.

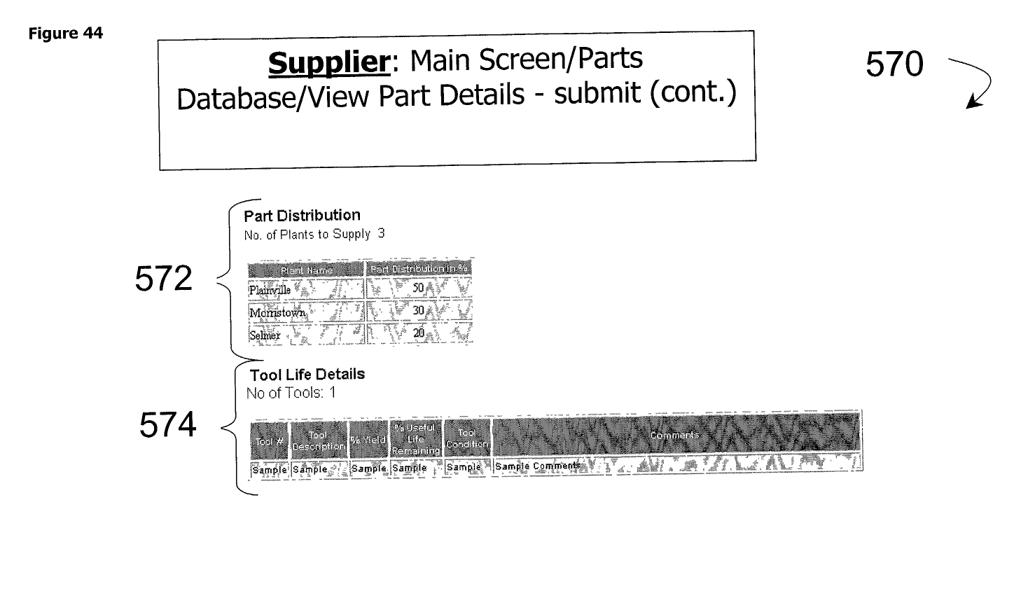

FIG. 44 is a continuation page of a Supplier Main Screen/Parts Database/View Part Details—submit page, as depicted in screen shot 570. Screen shot 570 includes a Part Distribution display area 572 that displays the distribution of manufacture of a part between different plants. Screen shot 570 also includes a Tool Life Details selection area 574 in which in one embodiment the user can specify the number of a tool, a description of a tool, and percent yield, the percent useful life remaining, the condition of the tool, and any comments.

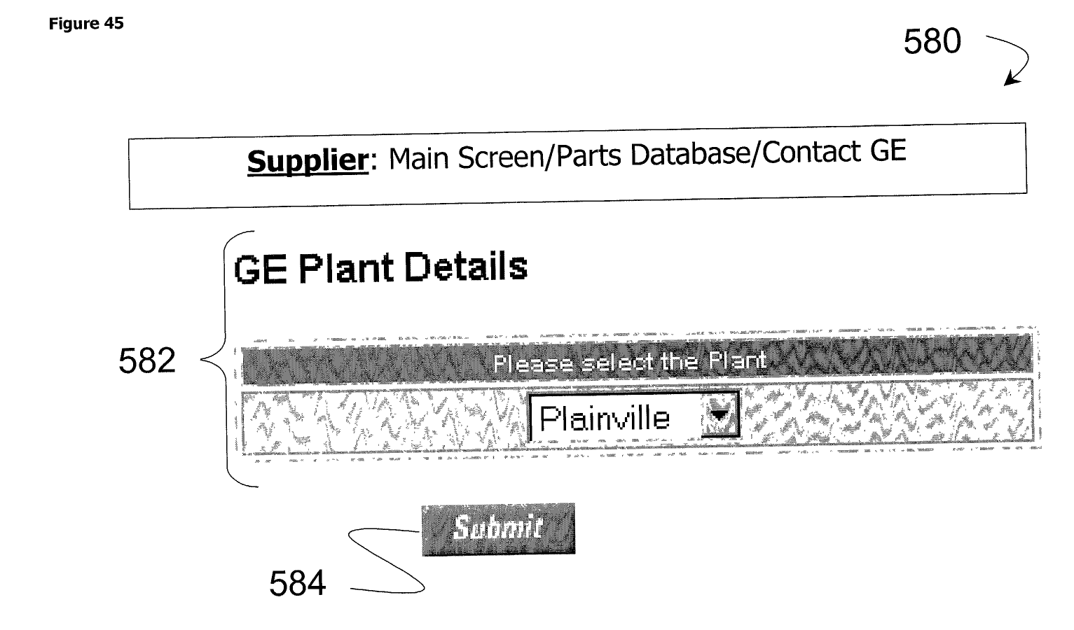

FIG. 45 shows an exemplary embodiment of a Supplier Main Screen/Parts Database/Contact GE page, as depicted in screen shot 580. Screen shot 580 includes a GE Plant Details selection area 582 that includes a pull down menu for specifying a GE plant. Screen shot 580 also includes a Submit radio button 584.

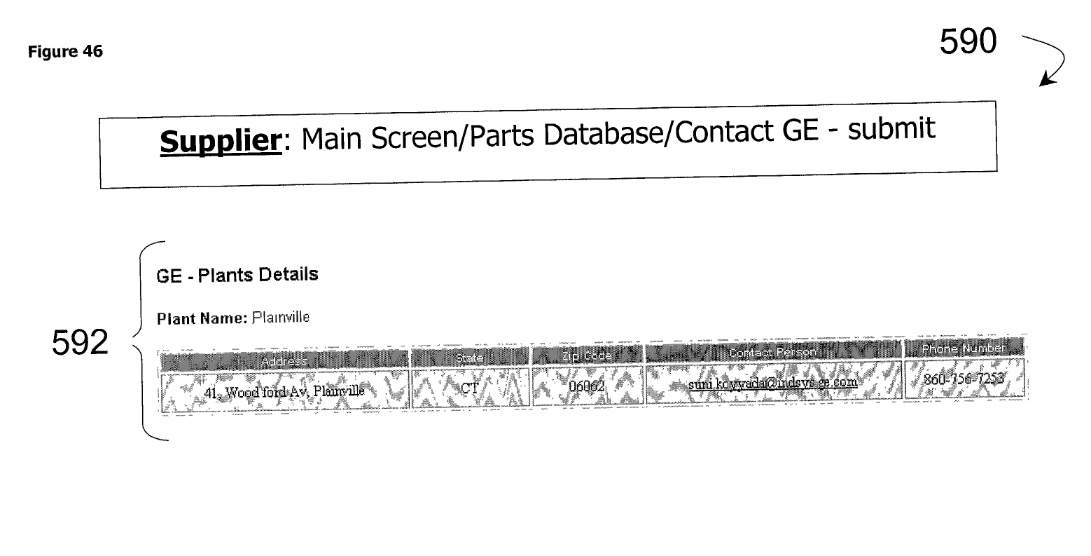

FIG. 46 shows an exemplary embodiment of a Supplier Main Screen/Parts Database/Contact Supplier—submit page, as depicted in screen shot 590. Screen shot 590 includes a GE—Plants and Details display area 592 that displays information about a plant, in one embodiment including its address, and contact information such as an email address or phone number.

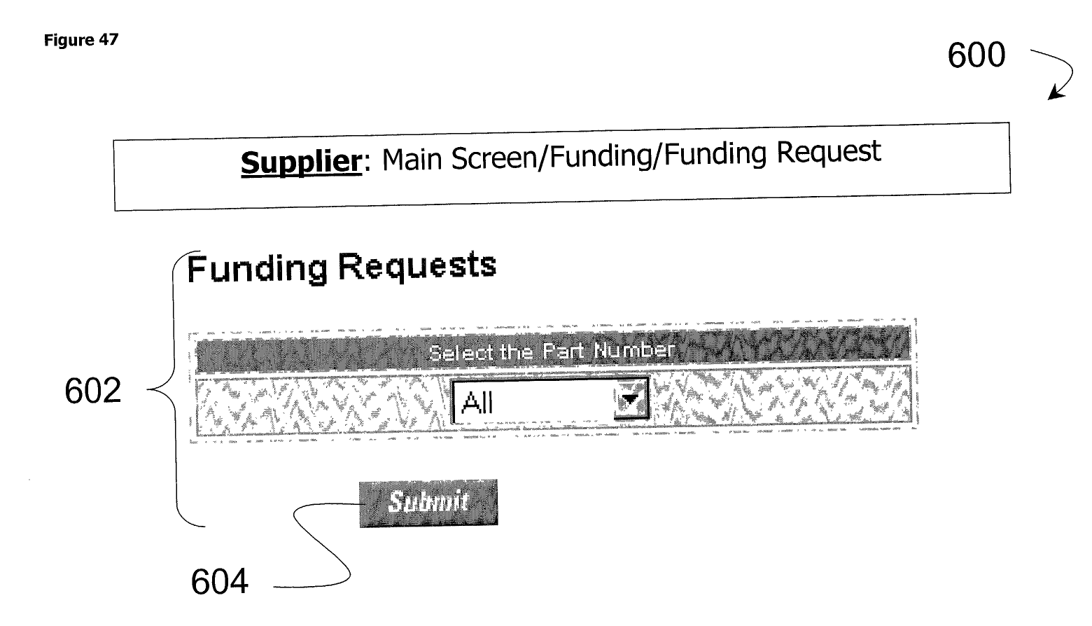

FIG. 47 shows an exemplary embodiment of a Supplier Main Screen/Funding/Funding Request page, as depicted in screen shot 600. Screen shot 600 includes a Funding Requests selection area 602 that includes a pull down menu by which the user can specify a part number. Screen shot 600 also includes a Submit radio button 604.

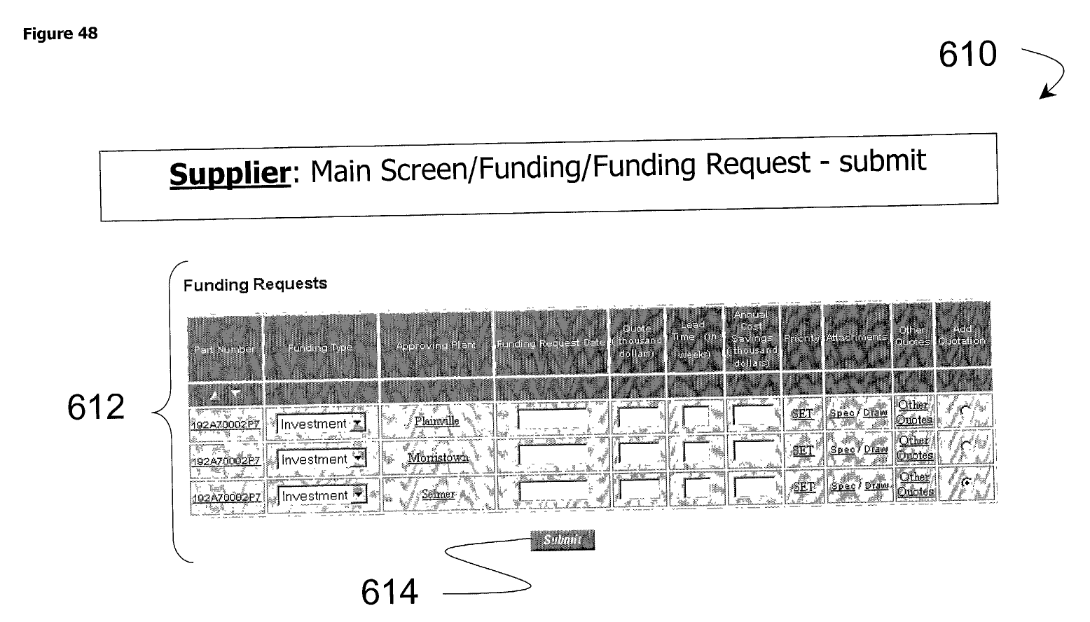

FIG. 48 shows an exemplary embodiment of a Supplier Main Screen/Funding/Funding Request—submit page, as depicted in screen shot 610. Screen shot 610 includes a Funding Requests selection area 612 that includes a display area that displays a part number, a pull down menu for specifying funding type, a quote, a lead time, an annual cost savings, and a priority. Screen shot 610 also includes a Submit radio button 614.

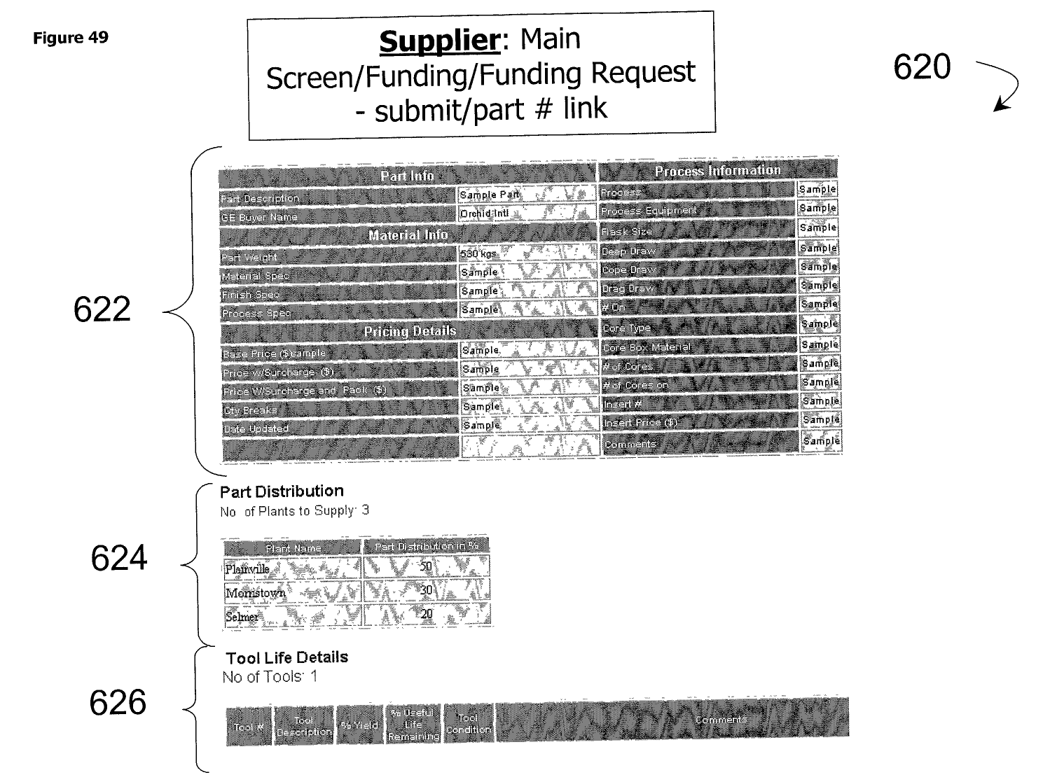

FIG. 49 shows an exemplary embodiment of a Supplier Main Screen/Funding/Funding Request—submit/part # link page, as depicted in screen shot 620. Screen shot 620 includes a View Part Details selection area 622 in which the user can specify information about a part, including one embodiment its description, its price, and details concerning its physical properties and a processed by which it is manufactured. Screen shot 620 includes a Part Distribution selection area 624, in which the user can specify the percentage of the manufactured parts that is produced by which plant. Screen shot 620 also includes a Tool Life Details selection area 626 in which the user can specify a one embodiment the number of a tool, its description tool, its percent yield, its percent useful life remaining, its condition, and any comments.

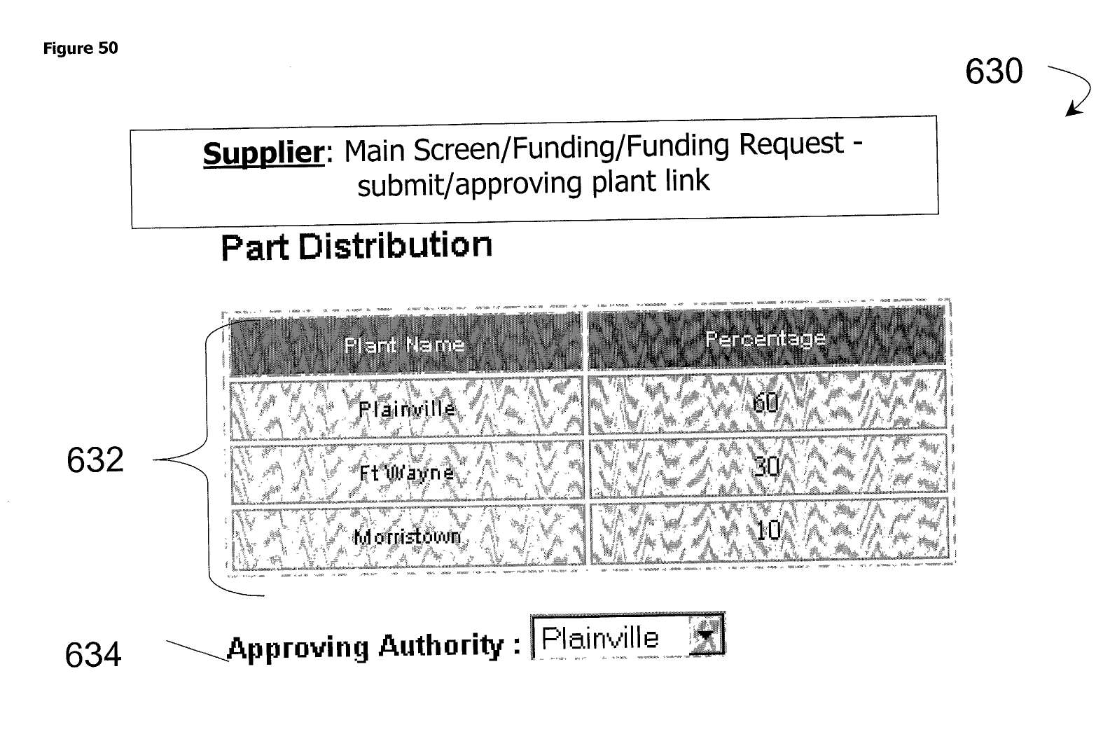

FIG. 50 shows an exemplary embodiment of a Supplier Main Screen/Funding/Funding Request—submit/approving plant link page, as depicted in screen shot 630. Screen shot 630 includes a Part Distribution selection area 632 in which the user can specify the percentage of the manufactured parts that is produced by which plant. Screen shot 630 also includes an Approving Authority pull down menu 634 where user can specify an improving authority for manufacture of the tool.

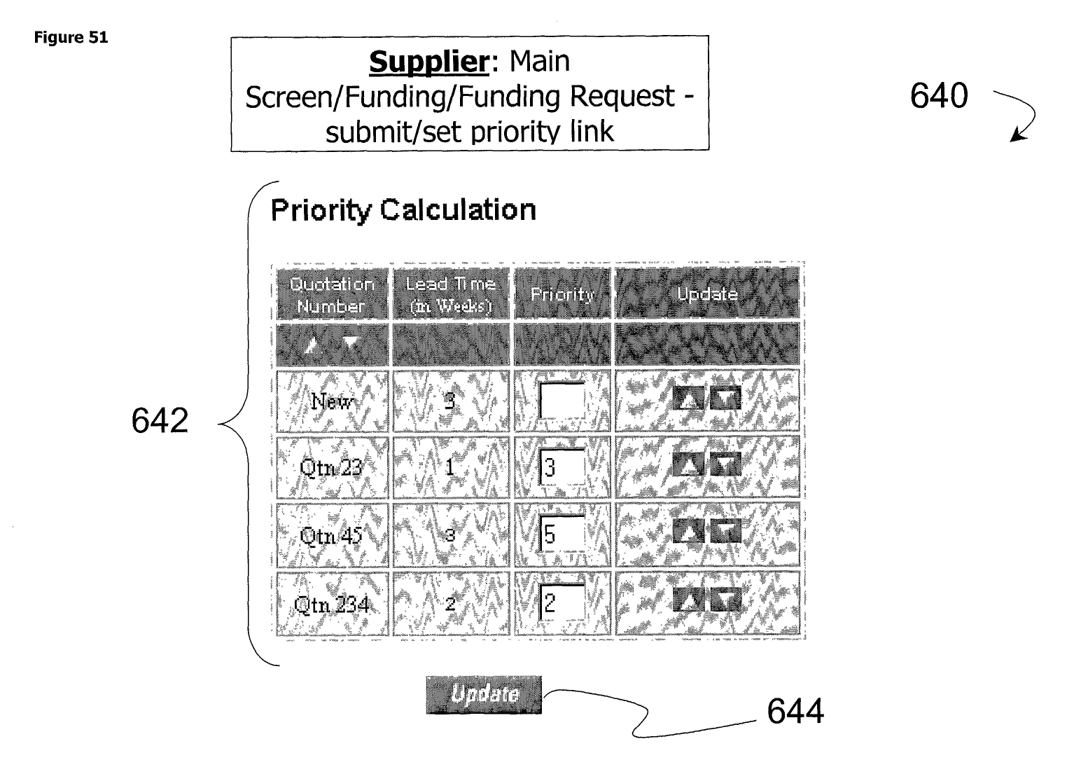

FIG. 51 shows an exemplary embodiment of a Supplier Main Screen/Funding/Funding Request—submit/set priority link page, as depicted in screen shot 640. Screen shot 640 includes a Priority Calculation selection area 642 that in one embodiment displays a quotation number, a lead time, and that allows the user to specify a priority and to update the priority information. Screen shot 640 also includes an Update radio buttons 644.

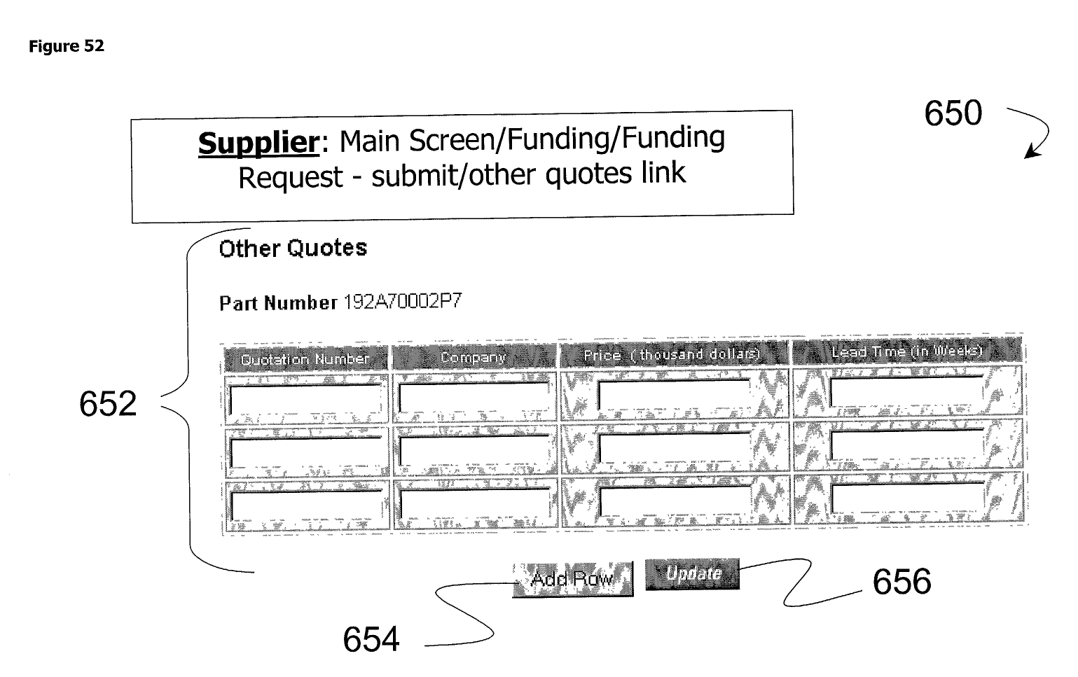

FIG. 52 shows an exemplary embodiment of a Supplier Main Screen/Funding/Funding Request—submit/other quotes link page, as depicted in screen shot 650. Screen shot 650 includes an Other Quotes selection area 652 in which the user can specify details of other quotes, including in one embodiment a quotation number, a company, a price, and a lead time. Screen shot 650 also includes an Add Row radio button 654 and an Update radio button 656.

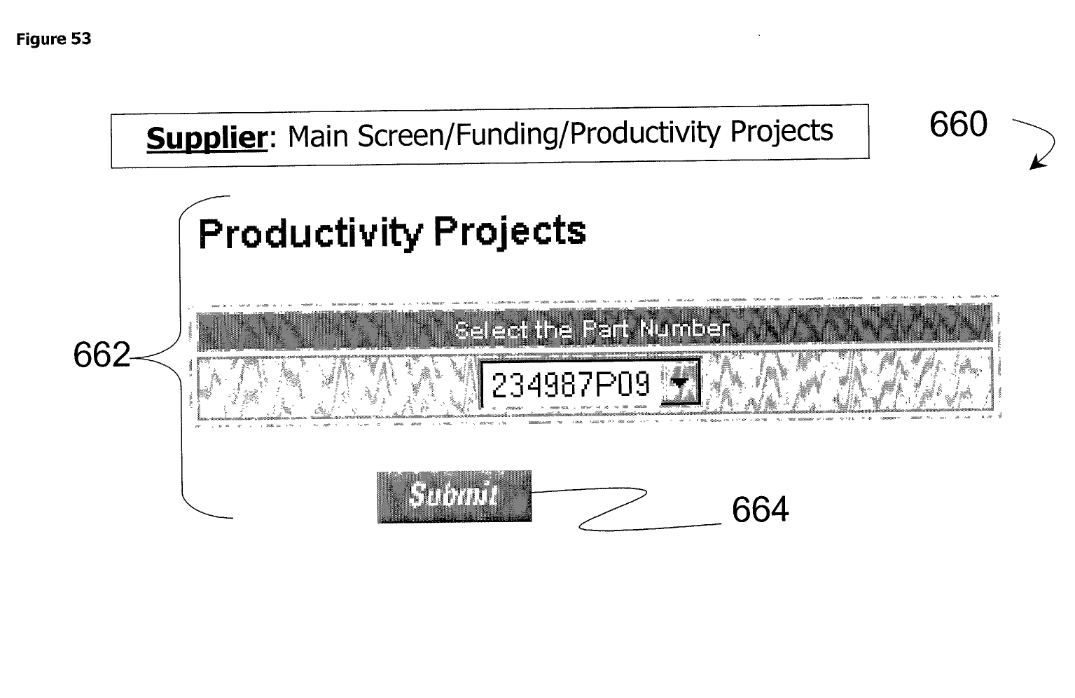

FIG. 53 shows an exemplary embodiment of a Supplier Main Screen/Funding/Productivity Projects page, as depicted in screen shot 660. Screen shot 660 includes a Productivity Projects selection area 662 that includes a pull down menu for specifying a part number and a Submit radio buttons 664.

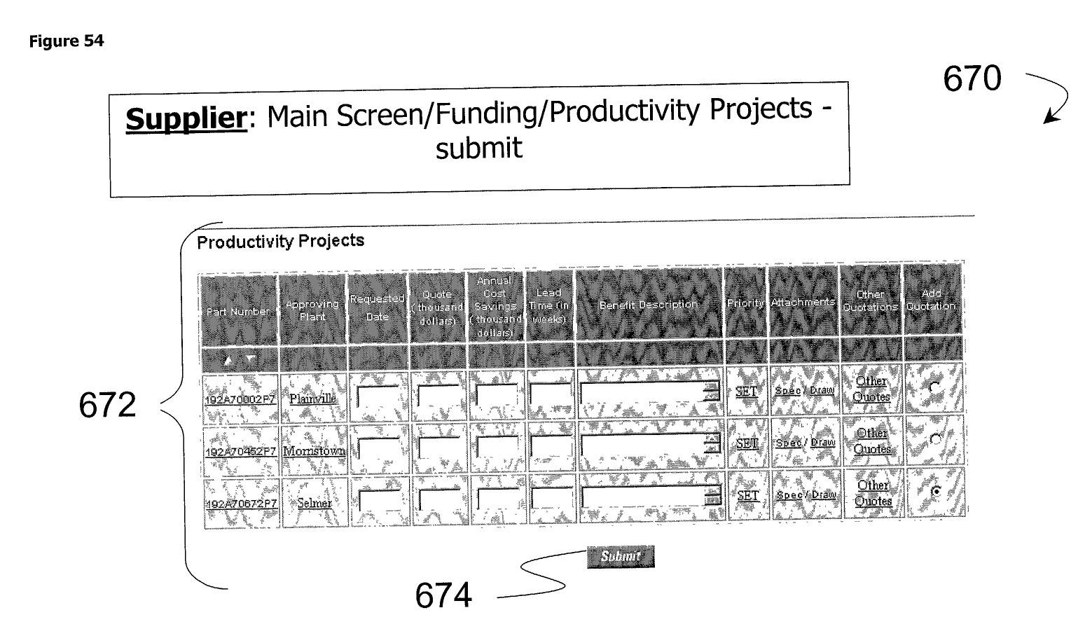

FIG. 54 shows an exemplary embodiment of a Supplier Main Screen/Funding/Productivity Projects—submit page, as depicted in screen shot 670. Screen shot 670 includes a Productivity Projects selection area 672 that in one embodiment displays a part number and an approving plant, and provides text boxes where the user can specify a requested date, a quote, and annual cost savings, a lead time, and a benefit description. Productivity Projects selection area 672 also includes a hyper link that allows a user to set a priority and to specify attachments and enter or other quotations. Screen shot 670 also includes a Submit radio button 674.

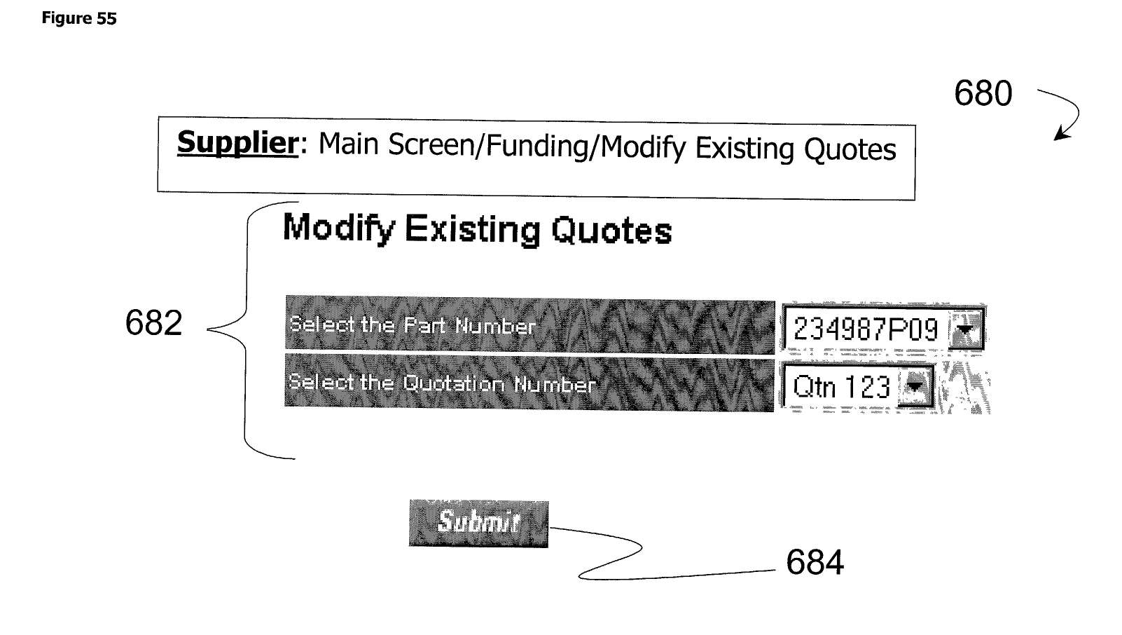

FIG. 55 shows an exemplary embodiment of a Supplier Main Screen/Funding/Modify Existing Quotes page, as depicted in screen shot 680. Screen shot 680 includes a Modify Existing Quotes selection area 682 that includes pull down menus for specifying a part number and a quotation number. Screen shot 680 also includes a Submit radio button 684.

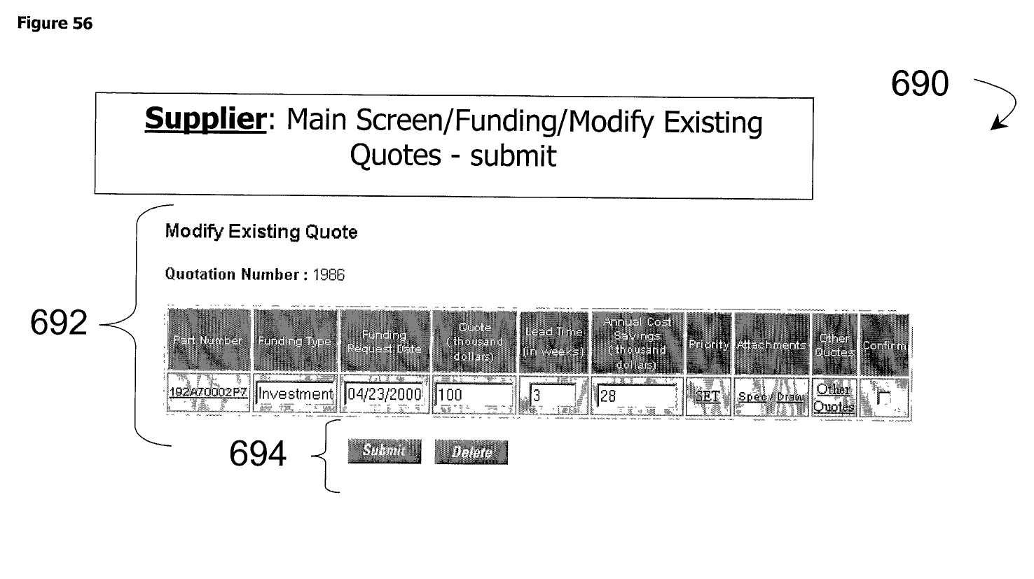

FIG. 56 shows an exemplary embodiment of a Supplier Main Screen/Funding/Modify Existing Quotes—submit page, as depicted in screen shot 690. Screen shot 690 includes a Modified Existing Quote display area 692 that includes a display area that displays a part number, a pull down menu for specifying funding type, a quote, a lead time, an annual cost savings, and a priority. Screen shot 690 also includes a set of Submit and Delete radio buttons 694.

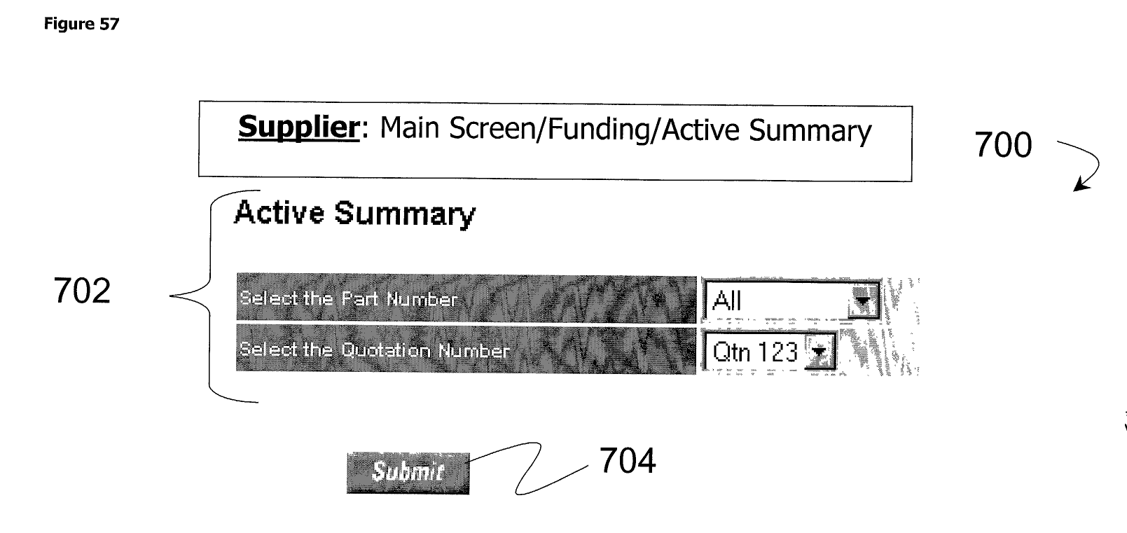

FIG. 57 shows an exemplary embodiment of a Supplier Main Screen/Funding/Active Summary page, as depicted in screen shot 700. Screen shot 700 includes an Active Summary selection area 702 that includes pull down menus for specifying a part number and a quotation number, and a Submit radio button 704.

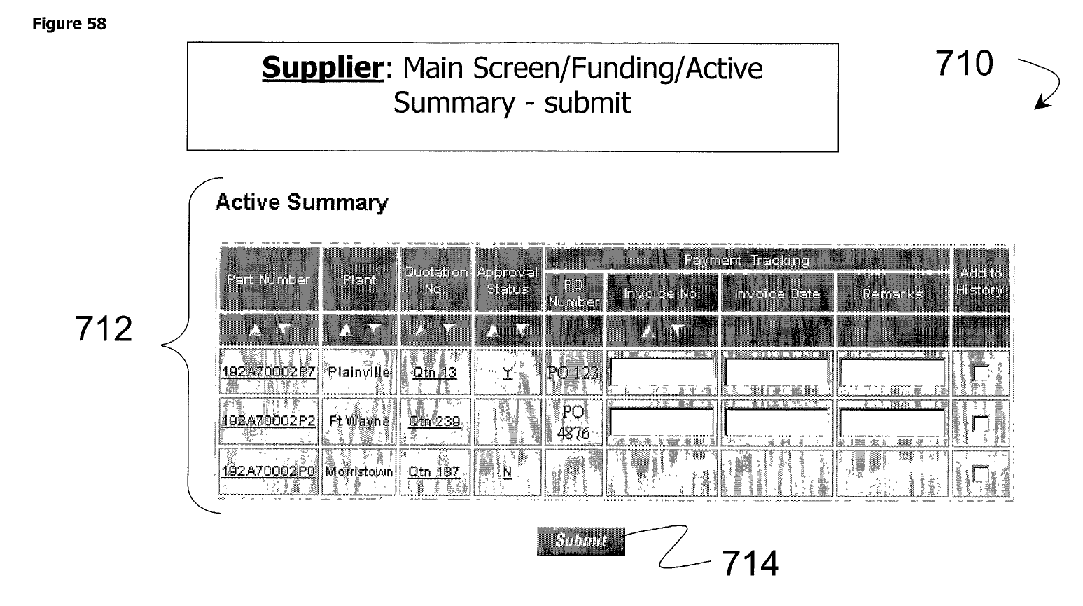

FIG. 58 shows an exemplary embodiment of a Supplier Main Screen/Funding/Active Summary—submit page, as depicted in screen shot 710. Screen shot 710 includes and Active Summary selection area 712 that displays a part number, a plant name, a quotation number, an approval status, and a purchase order number. Selection area 712 also includes text boxes where the user can specify an invoice number, an invoice date, and any remarks, and also an add to history check box. Screen shot 710 also includes a Submit radio button 714.

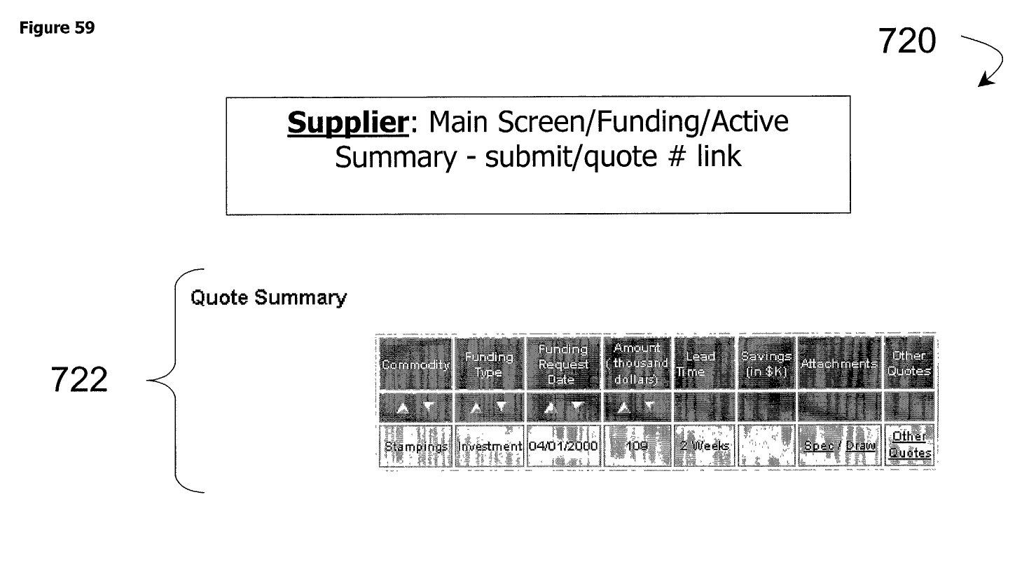

FIG. 59 shows an exemplary embodiment of a Supplier Main Screen/Funding/Active Summary≦submit/quote # link page, as depicted in screen shot 720. Screen shot 720 includes a Quote Summary display area 722 bed and one embodiment displays a commodity name, a funding type, a funding request date, an amount, a lead time, the savings, an attachment, and any other quotes.

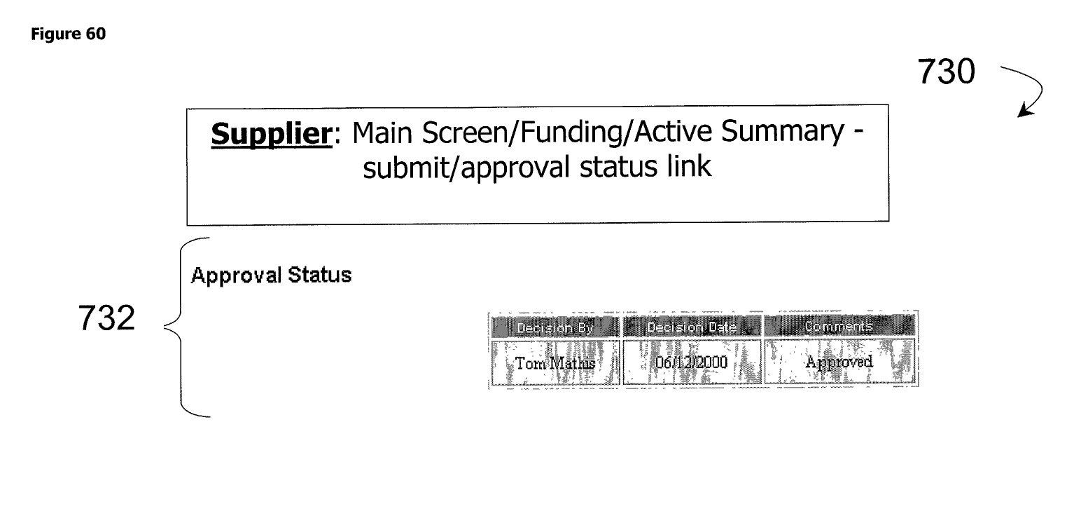

FIG. 60 shows an exemplary embodiment of a Supplier Main Screen/Funding/Active Summary—submit/approval status link page, as depicted in screen shot 730. Screen shot 730 includes and Approval Status display area 732 that in one embodiment displays the name of the person granting approval, the date of the decision, and comments.

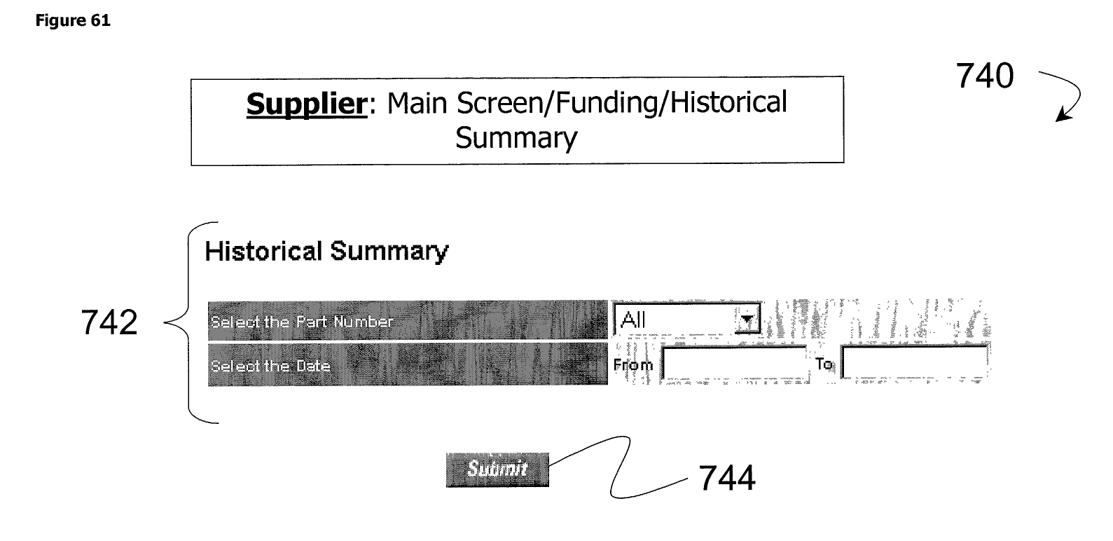

FIG. 61 shows an exemplary embodiment of a Supplier Main Screen/Funding/Historical Summary page, as depicted in screen shot 740. Screen shot 740 includes a Historical Summary selection area 742 that includes pull down menus for specifying a part number and a date. Screen shots 740 also includes a Submit radio button 744.

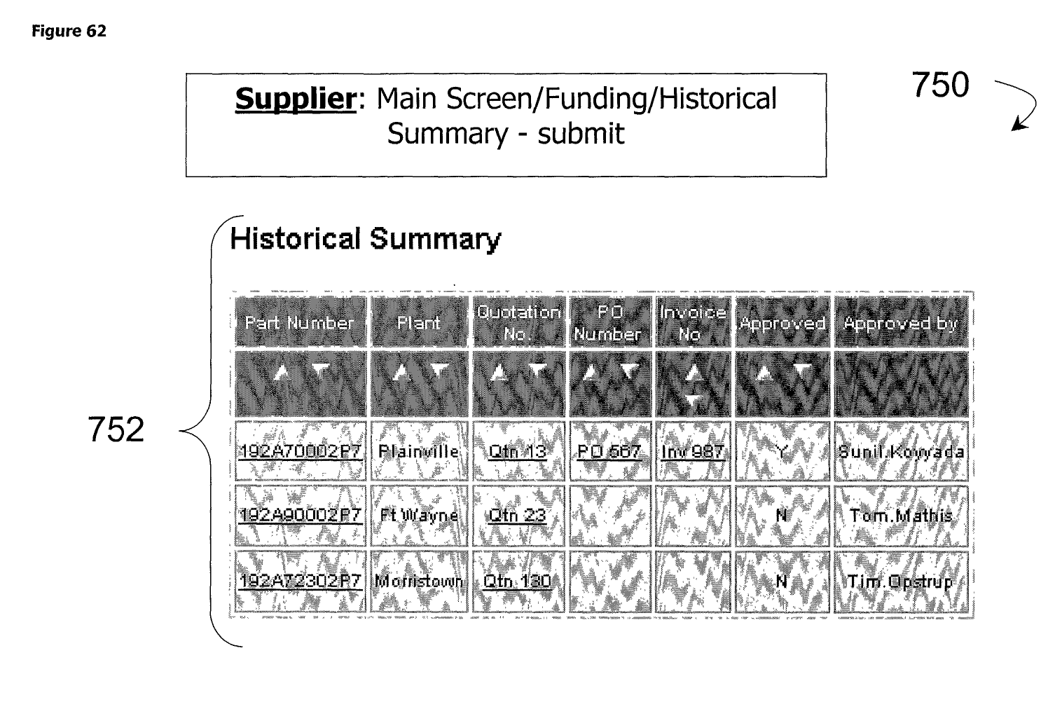

FIG. 62 shows an exemplary embodiment of a Supplier Main Screen/Funding/Historical Summary—submit page, as depicted in screen shot 750. Screen shot 750 includes a Historical Summary display area 752 that in one embodiment displays a part number, a plant name, a quotation number, a purchase order number, and invoice number, and approval status, and the name of the person who granted or withheld approval.

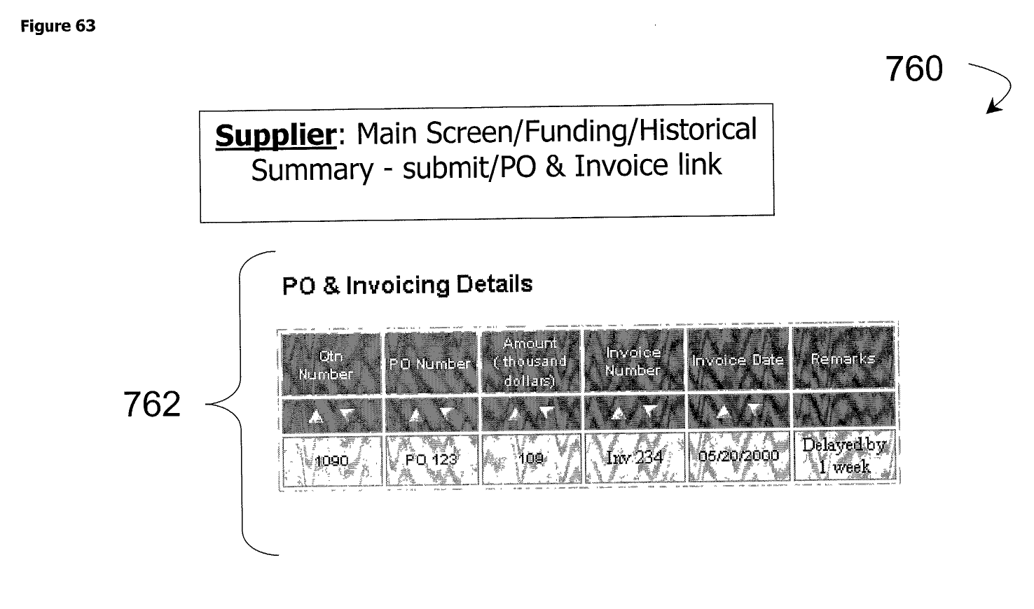

FIG. 63 shows an exemplary embodiment of a Supplier Main Screen/Funding/Historical Summary—submit/PO & Invoice link page, as depicted in screen shot 760. Screen shot 760 includes a PO & Invoicing Details display area 762 that in one embodiment displays a quotation number, a purchase order number, an amount, an invoice number, invoice date, and remarks.

In use, a supplier submits to system 10 a new request to the manufacturer to obtain funding to buy a tool to make parts for the manufacturer. The manufacturer views the new request and decides whether to fund the request. If the decision is favorable, the funding request is filed as approved awaiting purchase order until the manufacturer generates a purchase order, when the funding request is filed as approved awaiting completion. Once the tool is completed, the funding request is filed in the historical summary, where it can be accessed from the historical summary page.

System 10 facilitates an easy and efficient method for soliciting and disseminating information concerning tools. System 10 is a network-based system and is configured to permit users to access system 10 from remote locations through devices 14. While the invention has been described in terms of various specific embodiments, those skilled in the art will recognize that the invention can be practiced with modification within the spirit and scope of the claims.

What is claimed is:

1. A method for tracking and disseminating information concerning tools using a network-based system including a server and at least one device connected to the server via a network, said method comprising the steps of:
receiving information concerning the tool from a user via the device;
comparing the received product specification information with prestored information on tools; and
displaying information related to the tool.

2. A method in accordance with claim 1 wherein said step of receiving tool information comprises the step of receiving information pertaining to features selected by the user.

3. A method in accordance with claim 2 wherein said step of receiving information pertaining to features selected by the user comprises the step of receiving information regarding at least one of a part name, part number, and a name of a plant that manufactures the part.

4. A method in accordance with claim 1 wherein said step of receiving tool information data from a user further comprises the step of receiving a funding request for the tool.

5. A method in accordance with claim 4 wherein said step of receiving tool information data from a user further comprises the step of receiving approval or disapproval in response to a funding request for the tool.

6. A method in accordance with claim 1 wherein said step of displaying information related to the tool comprises the step of displaying a funding request pertaining to the tool.

7. A method in accordance with claim 1 wherein said step of displaying information related to the tool comprises the step of displaying a specification for the tool.

8. A method in accordance with claim 1 wherein said step of displaying information related to the tool comprises the step of displaying a price for the tool.

9. A method in accordance with claim 1 wherein said step of displaying information related to the tool comprises the step of displaying information pertaining to the process by which the tool is made.

10. A method in accordance with claim 1 wherein said step of displaying information related to the tool comprises the step of displaying a name of a plant where the tool is manufactured.

11. A method in accordance with claim 1 wherein said step of displaying information related to the tool comprises the step of displaying a useful remaining life of the tool.

12. A method in accordance with claim 1 wherein said step of displaying information related to the tool comprises the step of displaying a condition of the tool.

13. A method in accordance with claim 1 wherein said step of displaying information related to the tool comprises the step of displaying a quote for the tool.

14. A method in accordance with claim 1 wherein the product specification information is received from the user via a graphical user interface.

15. A system for facilitating dissemination of information concerning a tool, said system comprising:
a device; and
a server connected to said device and configured to receive tool product specification information data from a user via said device, said server further configured to:
compare the received product specification information with pre-stored tool information;
select at least one tool from the pre-stored tool information data that matches the tool identification data entered by the user; and
display to the user information related to the selected tool.

16. A system in accordance with claim 14 wherein said server further configured to receive information pertaining to features selected by the user.

17. A system in accordance with claim 15 wherein said server further configured to receive information regarding at least one of a part name, part number, and a name of a plant that manufactures the part.

18. A system in accordance with claim 14 wherein said server further configured to receive the tool information from the user via a graphical user interface.

19. A system in accordance with claim 14 wherein said device configured to be a server for a network of customer devices.

20. A system in accordance with claim 14 wherein said server and said device are connected via a network.

21. A system in accordance with claim 19 wherein said network is one of a wide area network, a local area network and the Internet.
